(19) United States
(12) Patent Application Publication
(10) Pub. No.: US 2026/0342978 A1
(43) Pub. Date: Oct. 29, 2026

(54) Split-shape Multiparametric Reference Filtering for Inter Prediction

(71) Applicant: Ofinno, LLC, Reston, VA (US)

(72) Inventors: Alexey Konstantinovich Filippov, Khimki (RU); Vasily Alexeevich Rufitskiy, Vladimir (RU); Esmael Hejazi Dinan, McLean, VA (US)

(73) Assignee: Ofinno, LLC, Reston, VA (US)

(21) Appl. No.: 19/720,044

(22) Filed: Jun. 25, 2026

Related U.S. Application Data
(63) Continuation of application No. PCT/US2024/061936, filed on Dec. 26, 2024.
(60) Provisional application No. 63/616,734, filed on Dec. 31, 2023.

(51) Int. Cl. H04N 19/117; H04N 19/105; H04N 19/176; H04N 19/503; H04N 19/593

(52) U.S. Cl. CPC H04N 19/117; H04N 19/105; H04N 19/176; H04N 19/503; H04N 19/593

(57) ABSTRACT

A video coder (encoder or decoder) selects, for each spatial location of a plurality of first spatial locations in a current template of a current block in a current frame, a plurality of second spatial locations comprising at least one spatial location from each reference template of a plurality of reference templates. The plurality of reference templates is associated with a plurality of reference blocks in respective reference frames. The coder further calculates, using a system of equations specified for the plurality of second spatial locations and the plurality of first spatial locations, coefficients of a multi-tap filter corresponding to the plurality of reference blocks, generates a prediction of the current block based on applying, to the plurality of reference blocks, the multi-tap filter in accordance with the calculated coefficients, and codes the current block based on the prediction of the current block.

### CROSS-REFERENCE TO RELATED APPLICATIONS

This application is a continuation of International Application No. PCT/US2024/061936, filed Dec. 26, 2024, which claims the benefit of U.S. Provisional Application No. 63/616,734, filed Dec. 31, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary video coding/decoding system in which embodiments of the present disclosure may be implemented.

FIG. 2 illustrates an exemplary encoder in which embodiments of the present disclosure may be implemented.

FIG. 3 illustrates an exemplary decoder in which embodiments of the present disclosure may be implemented.

FIG. 4 illustrates an example quadtree partitioning of a coding tree block (CTB) in accordance with embodiments of the present disclosure.

FIG. 5 illustrates a corresponding quadtree of the example quadtree partitioning of the CTB in FIG. 4 in accordance with embodiments of the present disclosure.

FIG. 6 illustrates example binary and ternary tree partitions in accordance with embodiments of the present disclosure.

FIG. 7 illustrates an example quadtree+multi-type tree partitioning of a CTB in accordance with embodiments of the present disclosure.

FIG. 8 illustrates a corresponding quadtree+multi-type tree of the example quadtree+multi-type tree partitioning of the CTB in FIG. 7 in accordance with embodiments of the present disclosure.

FIG. 9 illustrates an example set of reference samples determined for intra prediction of a current block being encoded or decoded in accordance with embodiments of the present disclosure.

FIG. 10A illustrates the 35 intra prediction modes supported by HEVC in accordance with embodiments of the present disclosure.

FIG. 10B illustrates the 67 intra prediction modes supported by HEVC in accordance with embodiments of the present disclosure.

FIG. 11 illustrates the current block and reference samples from FIG. 9 in a two-dimensional x, y plane in accordance with embodiments of the present disclosure.

FIG. 12 illustrates an example angular mode prediction of the current block from FIG. 9 in accordance with embodiments of the present disclosure.

FIG. 13A illustrates an example of inter prediction performed for a current block in a current picture being encoded in accordance with embodiments of the present disclosure.

FIG. 13B illustrates an example horizontal component and vertical component of a motion vector in accordance with embodiments of the present disclosure.

FIG. 14 illustrates an example of bi-prediction, performed for a current block in accordance with embodiments of the present disclosure.

FIG. 15A illustrates an example location of five spatial candidate neighboring blocks relative to a current block being coded in accordance with embodiments of the present disclosure.

FIG. 15B illustrates an example location of two temporal, co-located blocks relative to a current block being coded in accordance with embodiments of the present disclosure.

FIG. 16 illustrates an example of IBC applied for screen content in accordance with embodiments of the present disclosure.

FIG. 17A shows a current block and a reference block with corresponding templates used in determining scale and offset parameters for local illumination compensation (LIC) during inter prediction.

FIG. 17B shows a process for calculating a predicted block when LIC is used during inter prediction.

FIG. 18A illustrates a process for calculating a predicted block in a random access configuration of bi-predictive inter prediction.

FIG. 18B illustrates a process for calculating a predicted block in a low delay B configuration of bi-predictive inter prediction.

FIG. 19 illustrates example split-shape multi-tap filters and example corresponding split-shapes that can be used for bi-predictive inter prediction, in accordance with some embodiments of the present disclosure.

FIG. 20A illustrates an example split-shape multi-tap filter from those shown in FIG. 19 in which both split-shapes are of the same shape and size, in accordance with some embodiments of the present disclosure.

FIG. 20B illustrates an example split-shape multi-tap filter from those shown in FIG. 19 in which the two split-shapes are of different shapes, in accordance with some embodiments of the present disclosure.

FIG. 21 illustrates an example split-shape two-tap filter in accordance with some embodiments of the present disclosure.

FIG. 22 illustrates a flowchart of an example method for applying split-shape multi-tap filtering to inter prediction at an encoder in accordance with embodiments of the present disclosure.

FIG. 23 illustrates a flowchart of an example method for applying split-shape multi-tap filtering to inter prediction at a decoder in accordance with embodiments of the present disclosure.

FIG. 24 illustrates a flowchart of an example method that adaptively uses one of a plurality of submodes for bi-prediction with CU-level weight (BCW) inter prediction of a current block in accordance with embodiments of the present disclosure.

FIG. 25 illustrates a flowchart of an example method in which template samples are classified into different groups according to their properties, and different types of split-shapes of the multi-tap filter are applied to the different groups in accordance with embodiments of the present disclosure.

FIG. 26 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Representing a video sequence in digital form may require a large number of bits. The data size of a video sequence in digital form may be too large for storage and/or transmission in many applications. Video encoding may be used to compress the size of a video sequence to provide for more efficient storage and/or transmission. Video decoding may be used to decompress a compressed video sequence for display and/or other forms of consumption.

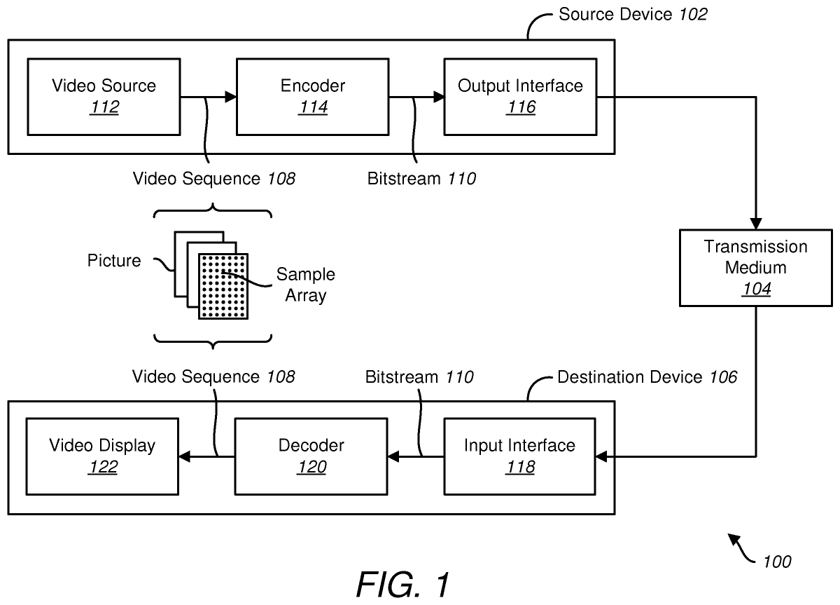

FIG. 1 illustrates an exemplary video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and destination device 106 may be any one of a number of different devices, including a desktop computer, laptop computer, tablet computer, smart phone, wearable device, television, camera, video gaming console, set-top box, or video streaming device.

To encode video sequence 108 into bitstream 110, source device 102 may comprise a video source 112, an encoder 114, and an output interface 116. Video source 112 may provide or generate video sequence 108 from a capture of a natural scene and/or a synthetically generated scene. A synthetically generated scene may be a scene comprising computer generated graphics or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

As shown in FIG. 1, a video sequence, such as video sequence 108, may comprise a series of pictures (also referred to as frames). A video sequence may achieve the impression of motion when a constant or variable time is used to successively present pictures of the video sequence. A picture may comprise one or more sample arrays of intensity values. The intensity values may be taken at a series of regularly spaced locations within a picture. A color picture typically comprises a luminance sample array and two chrominance sample arrays. The luminance sample array may comprise intensity values representing the brightness (or luma component, Y) of a picture. The chrominance sample arrays may comprise intensity values that respectively represent the blue and red components of a picture (or chroma components, Cb and Cr) separate from the brightness. Other color picture sample arrays are possible based on different color schemes (e.g., an RGB color scheme). For color pictures, a pixel may refer to all three intensity values for a given location in the three sample arrays used to represent color pictures. A monochrome picture comprises a single, luminance sample array. For monochrome pictures, a pixel may refer to the intensity value at a given location in the single, luminance sample array used to represent monochrome pictures.

Encoder 114 may encode video sequence 108 into bitstream 110. To encode video sequence 108, encoder 114 may apply one or more prediction techniques to reduce redundant information in video sequence 108. Redundant information is information that may be predicted at a decoder and therefore may not be needed to be transmitted to the decoder for accurate decoding of the video sequence. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Before applying the one or more prediction techniques, encoder 114 may partition pictures of video sequence 108 into rectangular regions referred to as blocks. Encoder 114 may then encode a block using one or more of the prediction techniques.

For temporal prediction, encoder 114 may search for a block similar to the block being encoded in another picture (also referred to as a reference picture) of video sequence 108. The block determined during the search (also referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (also referred to as a residual) based on the difference between a block being encoded and a prediction block. The prediction error may represent non-redundant information that may be transmitted to a decoder for accurate decoding of a video sequence.

Encoder 114 may apply a transform to the prediction error (e.g. a discrete cosine transform (DCT)) to generate transform coefficients. Encoder 114 may form bitstream 110 based on the transform coefficients and other information used to determine prediction blocks (e.g., prediction types, motion vectors, and prediction modes). In some examples, encoder 114 may perform one or more of quantization and entropy coding of the transform coefficients and/or the other information used to determine prediction blocks before forming bitstream 110 to further reduce the number of bits needed to store and/or transmit video sequence 108.

Output interface 116 may be configured to write and/or store bitstream 110 onto transmission medium 104 for transmission to destination device 106. In addition or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into video sequence 108 for display, destination device 106 may comprise an input interface 118, a decoder 120, and a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode video sequence 108 from encoded bitstream 110. To decode video sequence 108, decoder 120 may generate prediction blocks for pictures of video sequence 108 in a similar manner as encoder 114 and determine prediction errors for the blocks. Decoder 120 may generate the prediction blocks using prediction types, prediction modes, and/or motion vectors received in bitstream 110 and determine the prediction errors using transform coefficients also received in bitstream 110. Decoder 120 may determine the prediction errors by weighting transform basis functions using the transform coefficients. Decoder 120 may combine the prediction blocks and prediction errors to decode video sequence 108. In some examples, decoder 120 may decode a video sequence that approximates video sequence 108 due to, for example, lossy compression of video sequence 108 by encoder 114 and/or errors introduced into encoded bitstream 110 during transmission to destination device 106.

Video display 122 may display video sequence 108 to a user. Video display 122 may comprise a cathode ray tube (CRT) display, liquid crystal display (LCD), a plasma display, light emitting diode (LED) display, or any other display device suitable for displaying video sequence 108.

It should be noted that video encoding/decoding system 100 is presented by way of example and not limitation. In the example of FIG. 1, video encoding/decoding system 100 may have other components and/or arrangements. For example, video source 112 may be external to source device 102. Similarly, video display 122 may be external to destination device 106 or omitted altogether where video sequence is intended for consumption by a machine and/or storage device. In another example, source device 102 may further comprise a video decoder and destination device 106 may comprise a video encoder. In such an example, source device 102 may be configured to further receive an encoded bitstream from destination device 106 to support two-way video transmission between the devices.

In the example of FIG. 1, encoder 114 and decoder 120 may operate according to any one of a number of proprietary or industry video coding standards. For example, encoder 114 and decoder 120 may operate according to one or more of International Telecommunications Union Telecommunication Standardization Sector (ITU-T) H.263, ITU-T H.264 and Moving Picture Expert Group (MPEG)-4 Visual (also known as Advanced Video Coding (AVC), ITU-T H.265 and MPEG-H Part 2 (also known as High Efficiency Video Coding (HEVC), ITU-T H.265 and MPEG-I Part 3 (also known as Versatile Video Coding (VVC), the WebM VP8 and VP9 codecs, and AOMedia Video 1 (AV1).

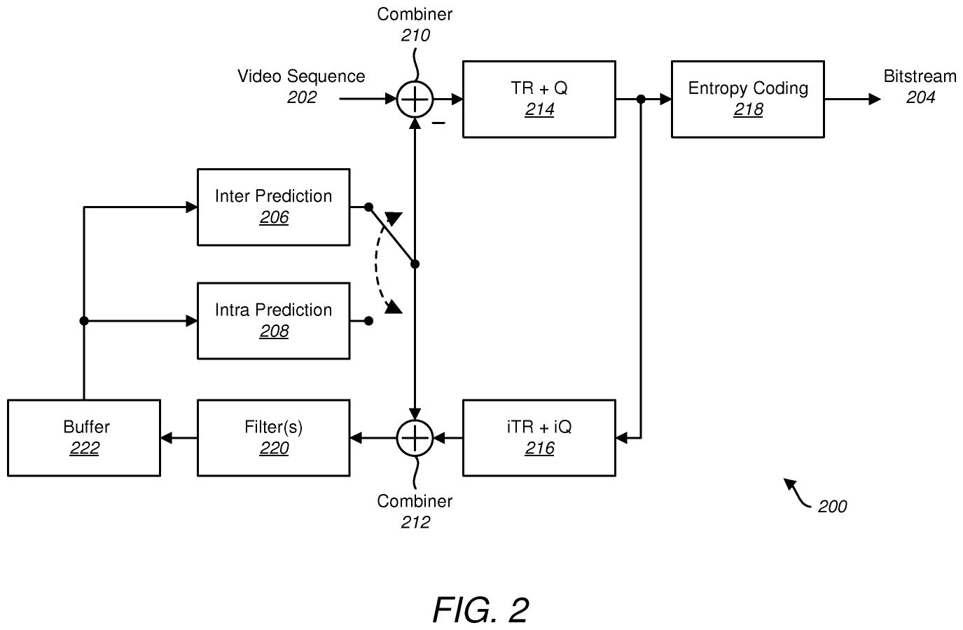

FIG. 2 illustrates an exemplary encoder 200 in which embodiments of the present disclosure may be implemented. Encoder 200 encodes a video sequence 202 into a bitstream 204 for more efficient storage and/or transmission. Encoder 200 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Encoder 200 comprises an inter prediction unit 206, an intra prediction unit 208, combiners 210 and 212, a transform and quantization unit (TR+Q) unit 214, an inverse transform and quantization unit (iTR+iQ) 216, entropy coding unit 218, one or more filters 220, and a buffer 222.

Encoder 200 may partition the pictures of video sequence 202 into blocks and encode video sequence 202 on a block-by-block basis. Encoder 200 may perform a prediction technique on a block being encoded using either inter prediction unit 206 or intra prediction unit 208. Inter prediction unit 206 may perform inter prediction by searching for a block similar to the block being encoded in another, reconstructed picture (also referred to as a reference picture) of video sequence 202. A reconstructed picture refers to a picture that was encoded and then decoded. The block determined during the search (also referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

After prediction, combiner 210 may determine a prediction error (also referred to as a residual) based on the difference between the block being encoded and the prediction block. The prediction error may represent non-redundant information that may be transmitted to a decoder for accurate decoding of a video sequence.

Transform and quantization unit 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. Irrelevant information is information that may be removed from the coefficients without producing visible and/or perceptible distortion in video sequence 202 after decoding.

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and syntax-based context-based binary arithmetic coding (SBAC). The entropy coded coefficients are packed to form bitstream 204.

Inverse transform and quantization unit 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block using, for example, a deblocking filter and/or a sample-adaptive offset (SAO) filter. Buffer 222 may store the reconstructed block for prediction of one or more other blocks in the same and/or different picture of video sequence 202.

Although not shown in FIG. 2, encoder 200 further comprises an encoder control unit configured to control one or more of the units of encoder 200 shown in FIG. 2. The encoder control unit may control the one or more units of encoder 200 such that bitstream 204 is generated in conformance with the requirements of any one of a number of proprietary or industry video coding standards. For example, the encoder control unit may control the one or more units of encoder 200 such that bitstream 204 is generated in conformance with one or more of ITU-T H.263, AVC, HEVC, VVC, VP8, VP9, and AV1 video coding standards.

Within the constraints of a proprietary or industry video coding standard, the encoder control unit may attempt to minimize or reduce the bitrate of bitstream 204 and maximize or increase the reconstructed video quality. For example, the encoder control unit may attempt to minimize or reduce the bitrate of bitstream 204 given a level that the reconstructed video quality may not fall below, or attempt to maximize or increase the reconstructed video quality given a level that the bit rate of bitstream 204 may not exceed. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and one or more transform types and/or quantization parameters applied by transform and quantization unit 214. The encoder control unit may determine/control the above based on how the determination/control effects a rate-distortion measure for a block or picture being encoded. The encoder control unit may determine/control the above to reduce the rate-distortion measure for a block or picture being encoded.

After being determined, the prediction type used to encode a block (intra or inter prediction), prediction information of the block (intra prediction mode if intra predicted, motion vector, etc.), and transform and quantization parameters, may be sent to entropy coding unit 218 to be further compressed to reduce the bit rate. For example, entropy coding unit 218 may apply context adaptive variable length coding (CAVLC), context adaptive binary arithmetic coding (CABAC), and syntax-based context-based binary arithmetic coding (SBAC) to compress the prediction type used to encode a block (intra or inter prediction), prediction information of the block (intra prediction mode if intra predicted, motion vector, etc.), and transform and quantization parameters. The prediction type, prediction information, and transform and quantization parameters may be packed with the prediction error to form bitstream 204.

It should be noted that encoder 200 is presented by way of example and not limitation. In other examples, encoder 200 may have other components and/or arrangements. For example, one or more of the components shown in FIG. 2 may be optionally included in encoder 200, such as entropy coding unit 218 and filter(s) 220.

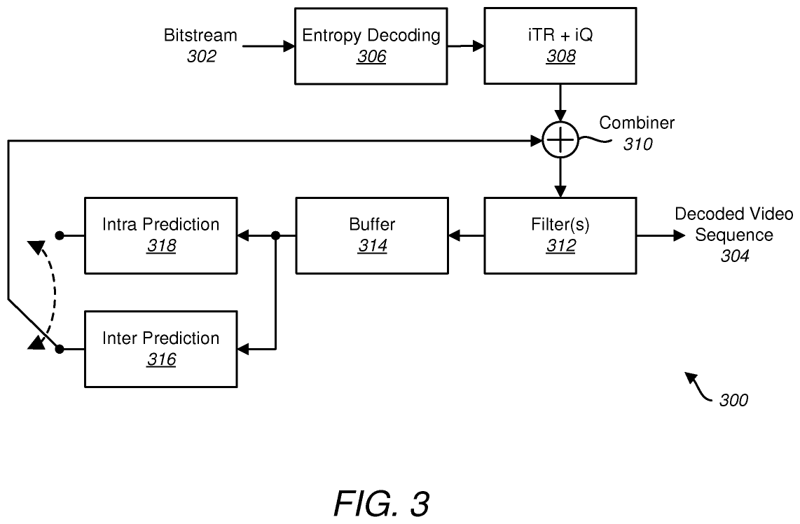

FIG. 3 illustrates an exemplary decoder 300 in which embodiments of the present disclosure may be implemented. Decoder 300 decodes a bitstream 302 into a decoded video sequence 304 for display and/or some other form of consumption. Decoder 300 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Decoder 300 comprises an entropy decoding unit 306, an inverse transform and quantization (iTR+iQ) unit 308, a combiner 310, one or more filters 312, a buffer 314, an inter prediction unit 316, and an intra prediction unit 318.

Although not shown in FIG. 3, decoder 300 further comprises a decoder control unit configured to control one or more of the units of decoder 300 shown in FIG. 3. The decoder control unit may control the one or more units of decoder 300 such that bitstream 302 is decoded in conformance with the requirements of any one of a number of proprietary or industry video coding standards. For example, the decoder control unit may control the one or more units of decoder 300 such that bitstream 302 is decoded in conformance with one or more of ITU-T H.263, AVC, HEVC, VVC, VP8, VP9, and AV1 video coding standards.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 as described above with respect to encoder 200 in FIG. 2. Filter(s) 312 may filter the decoded block using, for example, a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

It should be noted that decoder 300 is presented by way of example and not limitation. In other examples, decoder 300 may have other components and/or arrangements. For example, one or more of the components shown in FIG. 3 may be optionally included in decoder 300, such as entropy decoding unit 306 and filter(s) 312.

It should be further noted that, although not shown in FIGS. 2 and 3, each of encoder 200 and decoder 300 may further comprise an intra block copy unit in addition to inter prediction and intra prediction units. The intra block copy unit may perform similar to an inter prediction unit but predict blocks within the same picture. For example, the intra block copy unit may exploit repeated patterns that appear in screen content. Screen content may include, for example, computer generated text, graphics, and animation.

As mentioned above, video encoding and decoding may be performed on a block-by-block basis. The process of partitioning a picture into blocks may be adaptive based on the content of the picture. For example, larger block partitions may be used in areas of a picture with higher levels of homogeneity to improve coding efficiency.

In HEVC, a picture may be partitioned into non-overlapping square blocks, referred to as coding tree blocks (CTBs), comprising samples of a sample array. A CTB may have a size of 2n×2n samples, where n may be specified by a parameter of the encoding system. For example, n may be 4, 5, or 6. A CTB may be further partitioned by a recursive quadtree partitioning into coding blocks (CBs) of half vertical and half horizontal size. The CTB forms the root of the quadtree. A CB that is not split further as part of the recursive quadtree partitioning may be referred to as a leaf-CB of the quadtree and otherwise as a non-leaf CB of the quadtree. A CB may have a minimum size specified by a parameter of the encoding system. For example, a CB may have a minimum size of 4×4, 8×8, 16×16, 32×32, or 64×64 samples. For inter and intra prediction, a CB may be further partitioned into one or more prediction blocks (PBs) for performing inter and intra prediction. A PB may be a rectangular block of samples on which the same prediction type/mode may be applied. For transformations, a CB may be partitioned into one or more transform blocks (TBs). A TB may be a rectangular block of samples that may determine an applied transform size.

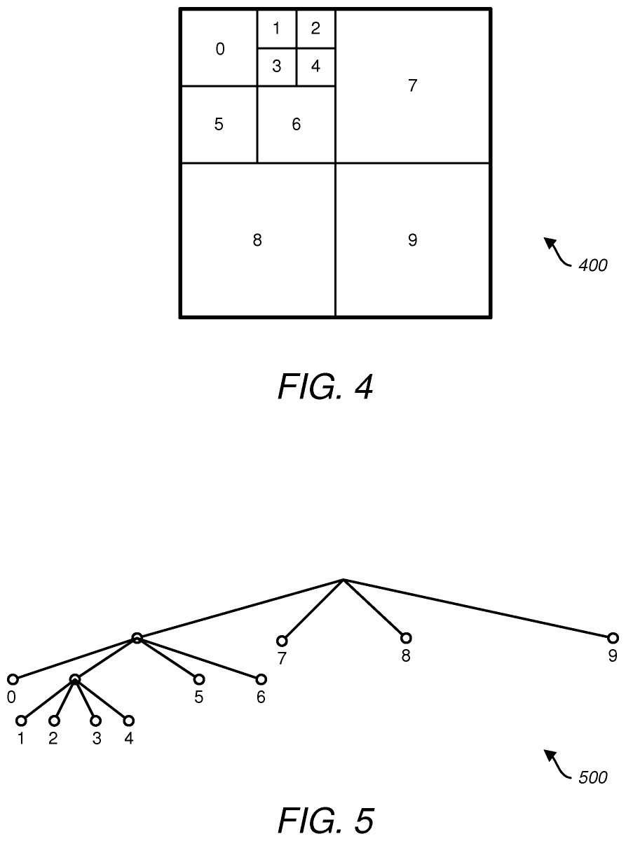

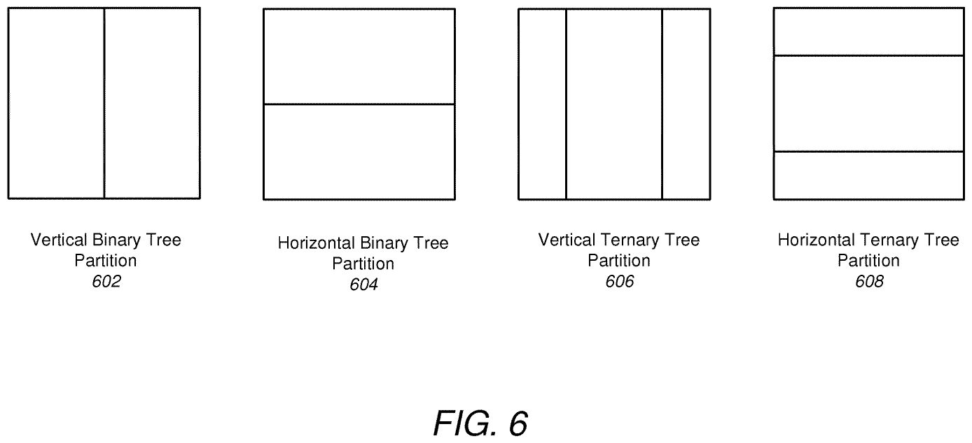

FIG. 4 illustrates an example quadtree partitioning of a CTB 400. FIG. 5 illustrates a corresponding quadtree 500 of the example quadtree partitioning of CTB 400 in FIG. 4. As shown in FIGS. 4 and 5, CTB 400 is first partitioned into four CBs of half vertical and half horizontal size. Three of the resulting CBs of the first level partitioning of CTB 400 are leaf-CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

Altogether, CTB 400 is partitioned into 10 leaf CBs respectively labeled 0-9. The resulting quadtree partitioning of CTB 400 may be scanned using a z-scan (left-to-right, top-to-bottom) to form the sequence order for encoding/decoding the CB leaf nodes. The numeric label of each CB leaf node in FIGS. 4 and 5 may correspond to the sequence order for encoding/decoding, with CB leaf node 0 encoded/decoded first and CB leaf node 9 encoded/decoded last. Although not shown in FIGS. 4 and 5, it should be noted that each CB leaf node may comprise one or more PBs and TBs.

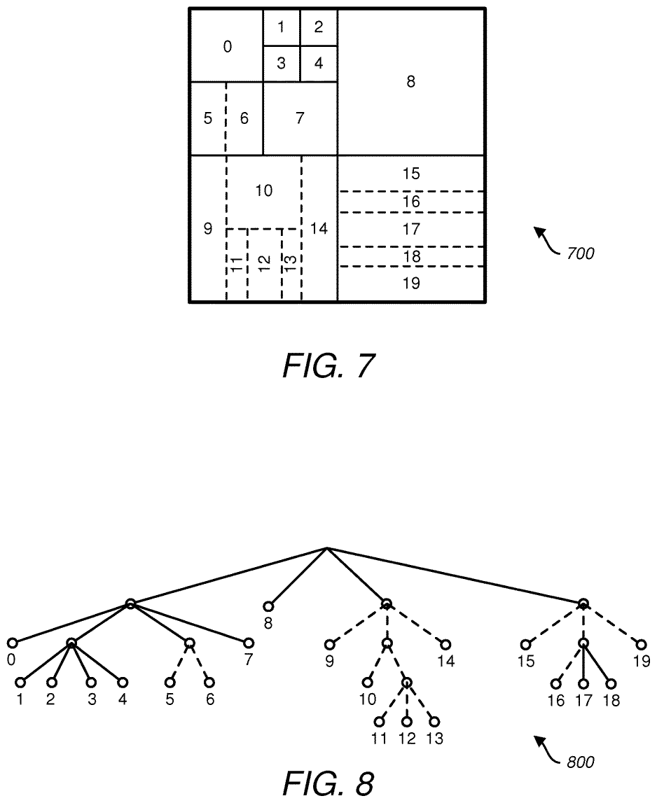

In VVC, a picture may be partitioned in a similar manner as in HEVC. A picture may be first partitioned into non-overlapping square CTBs. The CTBs may then be partitioned by a recursive quadtree partitioning into CBs of half vertical and half horizontal size. In VVC, a quadtree leaf node may be further partitioned by a binary tree or ternary tree partitioning into CBs of unequal sizes. FIG. 6 illustrates example binary and ternary tree partitions. A binary tree partition may divide a parent block in half in either the vertical direction 602 or horizontal direction 604. The resulting partitions may be half in size as compared to the parent block. A ternary tree partition may divide a parent block into three parts in either the vertical direction 606 or horizontal direction 608. The middle partition may be twice as large as the other two end partitions in a ternary tree partition.

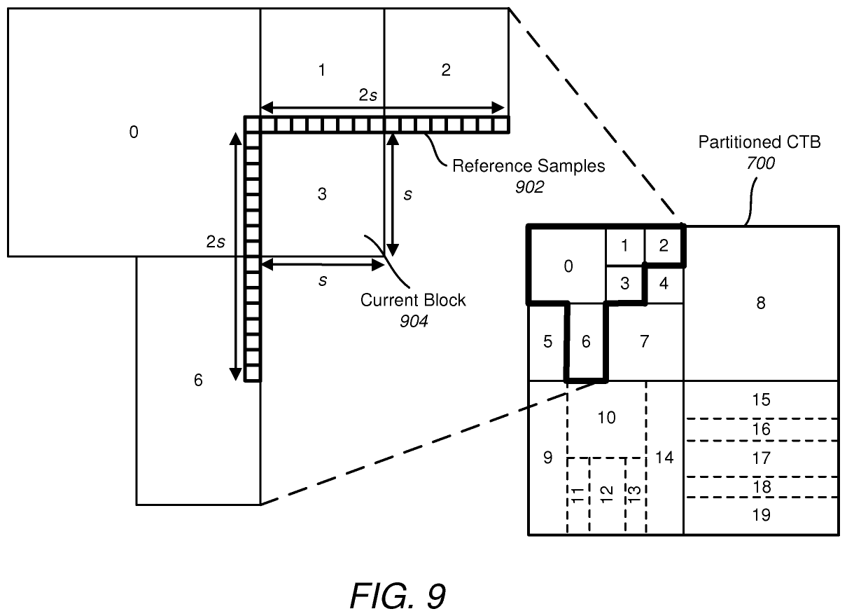

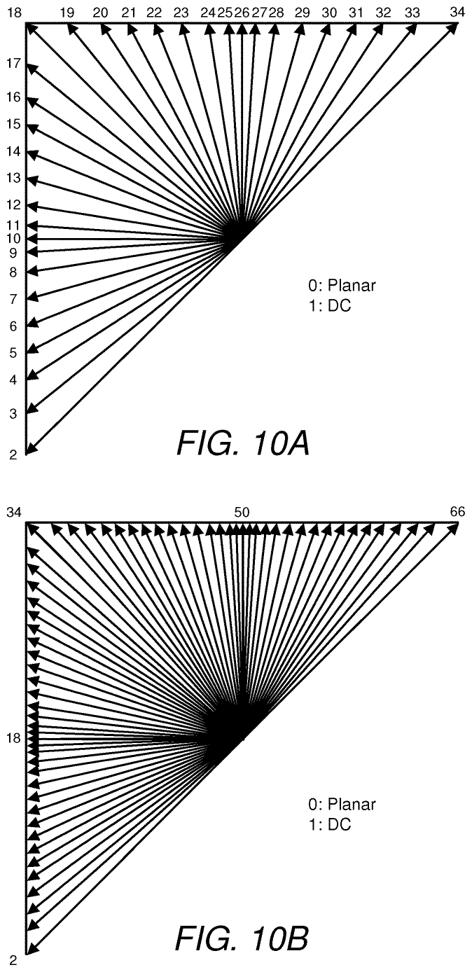

Because of the addition of binary and ternary tree partitioning, in VVC the block partitioning strategy may be referred to as quadtree+multi-type tree partitioning. FIG. 7 illustrates an example quadtree+multi-type tree partitioning of a CTB 700. FIG. 8 illustrates a corresponding quadtree+multi-type tree 800 of the example quadtree+multi-type tree partitioning of CTB 700 in FIG. 7. In both FIGS. 7 and 8, quadtree splits are shown in solid lines and multi-type tree splits are shown in dashed lines. For ease of explanation, CTB 700 is shown with the same quadtree partitioning as CTB 400 described in FIG. 4. Therefore, description of the quadtree partitioning of CTB 700 is omitted. The description of the additional multi-type tree partitions of CTB 700 is made relative to three leaf-CBs shown in FIG. 4 that have been further partitioned using one or more binary and ternary tree partitions. The three leaf-CBs in FIG. 4 that are shown in FIG. 7 as being further partitioned are leaf-CBs 5, 8, and 9.

Starting with leaf-CB 5 in FIG. 4, FIG. 7 shows this leaf-CB partitioned into two CBs based on a vertical binary tree partitioning. The two resulting CBs are leaf-CBs respectively labeled 5 and 6 in FIGS. 7 and 8. With respect to leaf-CB 8 in FIG. 4, FIG. 7 shows this leaf-CB partitioned into three CBs based on a vertical ternary tree partition. Two of the three resulting CBs are leaf-CBs respectively labeled 9 and 14 in FIGS. 7 and 8. The remaining, non-leaf CB is partitioned first into two CBs based on a horizontal binary tree partition, one of which is a leaf-CB labeled 10 and the other of which is further partitioned into three CBs based on a vertical ternary tree partition. The resulting three CBs are leaf-CBs respectively labeled 11, 12, and 13 in FIGS. 7 and 8. Finally, with respect to leaf-CB 9 in FIG. 4, FIG. 7 shows this leaf-CB partitioned into three CBs based on a horizontal ternary tree partition. Two of the three CBs are leaf-CBs respectively labeled 15 and 19 in FIGS. 7 and 8. The remaining, non-leaf CB is partitioned into three CBs based on another horizontal ternary tree partition. The resulting three CBs are all leaf-CBs respectively labeled 16, 17, and 18 in FIGS. 7 and 8.

Altogether, CTB 700 is partitioned into 20 leaf CBs respectively labeled 0-19. The resulting quadtree+multi-type tree partitioning of CTB 700 may be scanned using a z-scan (left-to-right, top-to-bottom) to form the sequence order for encoding/decoding the CB leaf nodes. The numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and TBs.

In addition to specifying various blocks (e.g., CTB, CB, PB, TB), HEVC and VVC further define various units. While blocks may comprise a rectangular area of samples in a sample array, units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bitstream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

It should be noted that the term block may be used to refer to any of a CTB, CB, PB, TB, CTU, CU, PU, or TU in the context of HEVC and VVC. It should be further noted that the term block may be used to refer to similar data structures in the context of other video coding standards. For example, the term block may refer to a macroblock in AVC, a macroblock or sub-block in VP8, a superblock or sub-block in VP9, or a superblock or sub-block in AV1.

In intra prediction, samples of a block to be encoded (also referred to as the current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted by projecting the position of the sample in the current block in a given direction (also referred to as an intra prediction mode) to a point along the reference samples. The sample may be predicted by interpolating between the two closest reference samples of the projection point if the projection does not fall directly on a reference sample. A prediction error (also referred to as a residual) may be determined for the current block based on differences between the predicted sample values and the original sample values of the current block.

At an encoder, this process of predicting samples and determining a prediction error based on a difference between the predicted samples and original samples may be performed for a plurality of different intra prediction modes, including non-directional intra prediction modes. The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block using the intra prediction mode indicated by the encoder and combining the predicted samples with the prediction error.

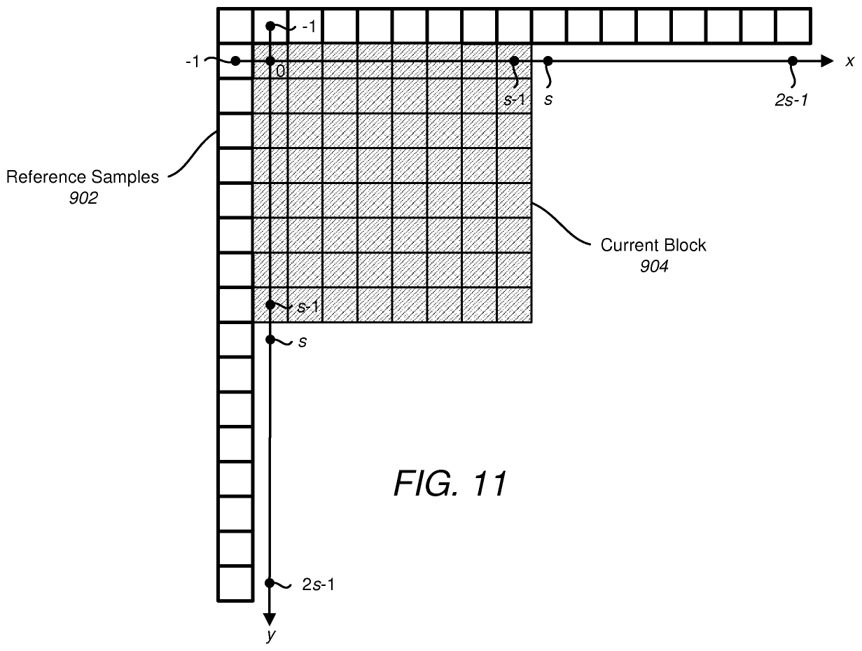

FIG. 9 illustrates an example set of reference samples 902 determined for intra prediction of a current block 904 being encoded or decoded. In FIG. 9, current block 904 corresponds to block 3 of partitioned CTB 700 in FIG. 7. As explained above, the numeric labels 0-19 of the blocks of partitioned CTB 700 may correspond to the sequence order for encoding/decoding the blocks and are used as such in the example of FIG. 9.

Given current block 904 is of w×h samples in size, reference samples 902 may extend over 2w samples of the row immediately adjacent to the top-most row of current block 904, 2h samples of the column immediately adjacent to the left-most column of current block 904, and the top left neighboring corner sample to current block 904. In the example of FIG. 9, current block 904 is square, so w=h=s. For constructing the set of reference samples 902, available samples from neighboring blocks of current block 904 may be used. Samples may not be available for constructing the set of reference samples 902 if, for example, the samples would lie outside the picture of the current block, the samples are part of a different slice of the current block (where the concept of slices are used), and/or the samples belong to blocks that have been inter coded and constrained intra prediction is indicated. When constrained intra prediction is indicated, intra prediction may not be dependent on inter predicted blocks.

In addition to the above, samples that may not be available for constructing the set of reference samples 902 include samples in blocks that have not already been encoded and reconstructed at an encoder or decoded at a decoder based on the sequence order for encoding/decoding. This restriction may allow identical prediction results to be determined at both the encoder and decoder. In FIG. 9, samples from neighboring blocks 0, 1, and 2 may be available to construct reference samples 902 given that these blocks are encoded and reconstructed at an encoder and decoded at a decoder prior to coding of current block 904. This assumes there are no other issues, such as those mentioned above, preventing the availability of samples from neighboring blocks 0, 1, and 2. However, the portion of reference samples 902 from neighboring block 6 may not be available due to the sequence order for encoding/decoding.

Unavailable ones of reference samples 902 may be filled with available ones of reference samples 902. For example, an unavailable reference sample may be filled with a nearest available reference sample determined by moving in a clock-wise direction through reference samples 902 from the position of the unavailable reference. If no reference samples are available, reference samples 902 may be filled with the mid-value of the dynamic range of the picture being coded.

It should be noted that reference samples 902 may be filtered based on the size of current block 904 being coded and an applied intra prediction mode. It should be further noted that FIG. 9 illustrates only one exemplary determination of reference samples for intra prediction of a block. In some proprietary and industry video coding standards, reference samples may be determined in a different manner than discussed above. For example, multiple reference lines may be used in other instances, such as used in VVC.

After reference samples 902 are determined and optionally filtered, samples of current block 904 may be intra predicted based on reference samples 902. Most encoders/decoders support a plurality of intra prediction modes in accordance with one or more video coding standards. For example, HEVC supports 35 intra prediction modes, including a planar mode, a DC mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture.

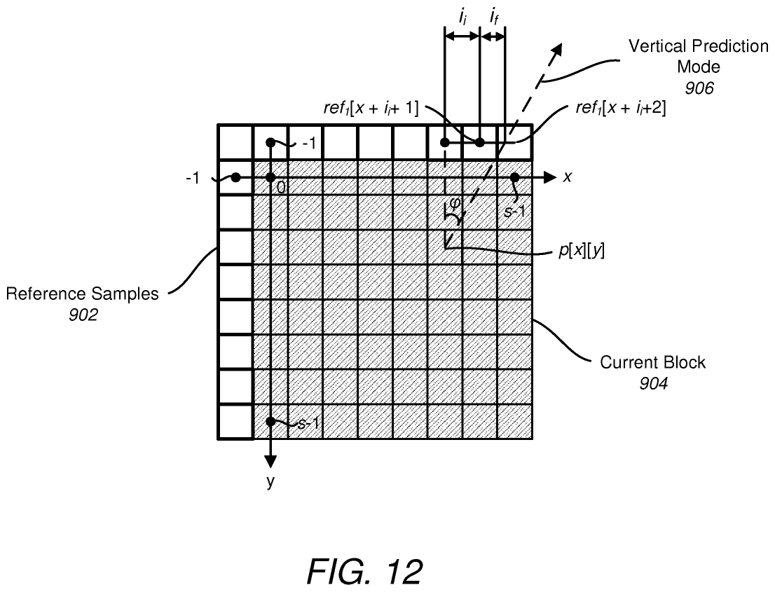

FIG. 10A illustrates the 35 intra prediction modes supported by HEVC. The 35 intra prediction modes are identified by indices 0 to 34. Prediction mode 0 corresponds to planar mode. Prediction mode 1 corresponds to DC mode. Prediction modes 2-34 correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B illustrates the 67 intra prediction modes supported by VVC. The 67 intra prediction modes are identified by indices 0 to 66. Prediction mode 0 corresponds to planar mode. Prediction mode 1 corresponds to DC mode. Prediction modes 2-66 correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Because blocks in VVC may be non-square, some of the intra prediction modes illustrated in FIG. 10B may be adaptively replaced by wide-angle directions.

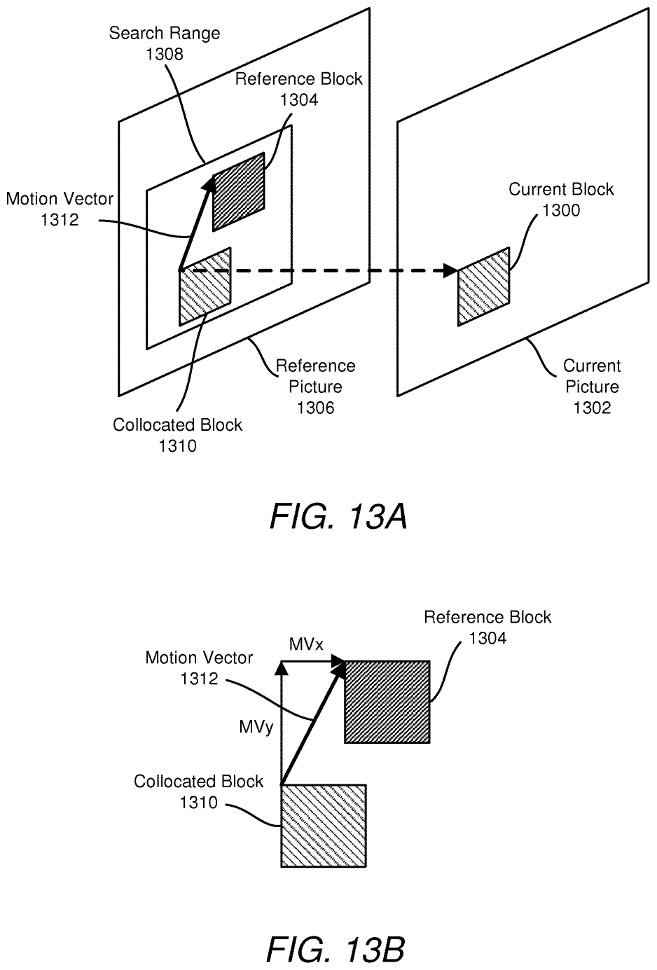

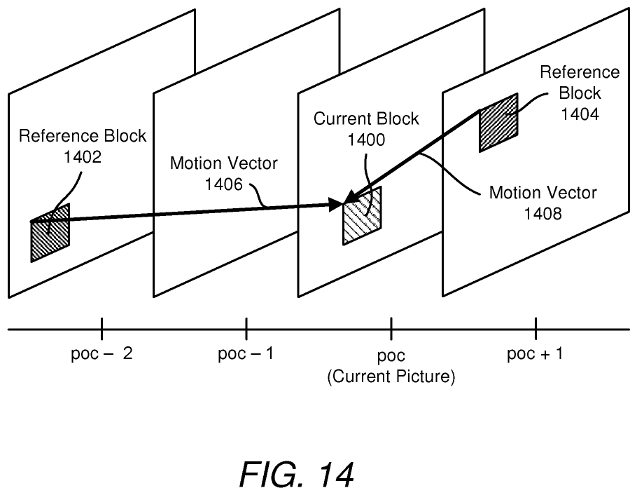

To further describe the application of intra prediction modes to determine a prediction of a current block, reference is made to FIGS. 11 and 12. In FIG. 11, current block 904 and reference samples 902 from FIG. 9 are shown in a two-dimensional x, y plane, where a sample may be referenced as p[x][y]. In order to simplify the prediction process, reference samples 902 may be placed in two, one-dimensional arrays. Reference samples 902 above current block 904 may be placed in the one-dimensional array ref₁[x]:

ref₁[x]=p[−1+x][−1],(x≥0) (1)

Reference samples 902 to the left of current block 904 may be placed in the one-dimensional array ref₂[x]:

ref₂[y]=p[−1][−1+y],(y≥0) (2)

For planar mode, a sample at location [x][y] in current block 904 may be predicted by calculating the mean of two interpolated values. The first of the two interpolated values may be based on a horizontal linear interpolation at location [x][y] in current block 904. The second of the two interpolated values may be based on a vertical linear interpolation at location [x][y] in current block 904. The predicted sample p[x][y] in current block 904 may be calculated as

$$p [ x ] [ y ] = \frac{1}{2 \cdot s} ( h [ x ] [ y ] + v [ x ] [ y ] + s ) \qquad ( 3 )$$

where

h[x][y]=(s−x−1)·ref₂[y]+(x+1)·ref₁[s] (4)

may be the horizontal linear interpolation at location [x][y] in current block 904 and

v[x][y]=(s−y−1)·ref₁[x]+(y+1)·ref₂[s] (5)

may be the vertical linear interpolation at location [x][y] in current block 904.

For DC mode, a sample at location [x][y] in current block 904 may be predicted by the mean of the reference samples 902. The predicted value sample p[x][y] in current block 904 may be calculated as

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) \qquad ( 6 )$$

For angular modes, a sample at location [x][y] in current block 904 may be predicted by projecting the location [x][y] in a direction specified by a given angular mode to a point on the horizontal or vertical line of samples comprising reference samples 902. The sample at location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC) and relative to the x-axis for horizontal prediction modes (e.g., modes 2-18 in HEVC and modes 2-34 in VVC).

FIG. 12 illustrates a prediction of a sample at location [x][y] in current block 904 for a vertical prediction mode 906 given by an angle φ. For vertical prediction modes, the location [x][y] in current block 904 is projected to a point (referred to herein as the “projection point”) on the horizontal line of reference samples ref₁[x]. Reference samples 902 are only partially shown in FIG. 12 for ease of illustration. Because the projection point falls at a fractional sample position between two reference samples in the example of FIG. 12, the predicted sample p[x][y] in current block 904 may be calculated by linearly interpolating between the two reference samples as follows

p[x][y]=(1−i_{f})·ref₁[x+iᵢ+1]+i_{f}·ref₁[x+iᵢ+2] (7)

where iᵢ is the integer part of the horizontal displacement of the projection point relative to the location [x][y] and may calculated as a function of the tangent of the angle φ of the vertical prediction mode 906 as follows

iᵢ=└(y+1)·tan φ┘, (8)

and i_{f} is the fractional part of the horizontal displacement of the projection point relative to the location [x][y] and may be calculated as

i_{f}=((y+1)·tan φ)−└(y+1)·tan φ┘. (9)

where ┐⋅┘ is the integer floor.

For horizontal prediction modes, the position [x][y] of a sample in current block 904 may be projected onto the vertical line of reference samples ref₂[y]. Sample prediction for horizontal prediction modes is given by:

p[x][y]=(1−i_{f})·ref₂[y+iᵢ+1]+i_{f}·ref₂[y+iᵢ+2] (10)

where iᵢ is the integer part of the vertical displacement of the projection point relative to the location [x][y] and may be calculated as a function of the tangent of the angle φ of the horizontal prediction mode as follows

iᵢ=└(x+1)·tan φ┘, (11)

and i_{f} is the fractional part of the vertical displacement of the projection point relative to the location [x][y] and may be calculated as

i_{f}=(x+1)·tan φ)−┘(x+1)·tan φ┘. (12)

where └⋅┘ is the integer floor.

The interpolation functions of (7) and (10) may be implemented by an encoder or decoder, such as encoder 200 in FIG. 2 or decoder 300 in FIG. 3, as a set of two-tap finite impulse response (FIR) filters. The coefficients of the two-tap FIR filters may be respectively given by (1−i_{f}) and i_{f}. In the above angular intra prediction examples, the predicted sample p[x][y] may be calculated with some predefined level of sample accuracy, such as 1/32 sample accuracy. For 1/32 sample accuracy, the set of two-tap FIR interpolation filters may comprise up to 32 different two-tap FIR interpolation filters—one for each of the 32 possible values of the fractional part of the projected displacement i_{f}. In other examples, different levels of sample accuracy may be used.

In an embodiment, the two-tap interpolation FIR filter may be used for predicting chroma samples. For luma samples, a different interpolation technique may be used. For example, for luma samples a four-tap FIR filter may be used to determine a predicted value of a luma sample. For example, the four tap FIR filter may have coefficients determined based on is, similar to the two-tap FIR filter. For 1/32 sample accuracy, a set of 32 different four-tap FIR filters may comprise up to 32 different four-tap FIR filters—one for each of the 32 possible values of the fractional part of the projected displacement i_{f}. In other examples, different levels of sample accuracy may be used. The set of four-tap FIR filters may be stored in a look-up table (LUT) and referenced based on i_{f}. The value of the predicted sample p[x][y], for vertical prediction modes, may be determined based on the four-tap FIR filter as follows:

$$p [ x ] [ y ] = {\sum }_{▯ = 0}^{3} fT [ i ] * ref [ x + iIdx + i ] \qquad ( 13 )$$

where ft[i], i=0 . . . 3, are the filter coefficients. The value of the predicted sample p[x][y], for horizontal prediction modes, may be determined based on the four-tap FIR filter as follows:

$$p [ x ] [ y ] = {\sum }_{▯ = 0}^{3} fT [ i ] * ref [ y + iIdx + i ] . \qquad ( 14 )$$

It should be noted that supplementary reference samples may be constructed for the case where the position [x][y] of a sample in current block 904 to be predicted is projected to a negative x coordinate, which happens with negative vertical prediction angles φ. The supplementary reference samples may be constructed by projecting the reference samples in ref₂[y] in the vertical line of reference samples 902 to the horizontal line of reference samples 902 using the negative vertical prediction angle φ. Supplemental reference samples may be similarly constructed for the case where the position [x][y] of a sample in current block 904 to be predicted is projected to a negative y coordinate, which happens with negative horizontal prediction angles φ. The supplementary reference samples may be constructed by projecting the reference samples in ref₁[x] on the horizontal line of reference samples 902 to the vertical line of reference samples 902 using the negative horizontal prediction angle φ.

An encoder may predict the samples of a current block being encoded, such as current block 904, for a plurality of intra prediction modes as explained above. For example, the encoder may predict the samples of the current block for each of the 35 intra prediction modes in HEVC or 67 intra prediction modes in VVC. For each intra prediction mode applied, the encoder may determine a prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may select one of the intra prediction modes to encode the current block based on the determined prediction errors. For example, the encoder may select an intra prediction mode that results in the smallest prediction error for the current block. In another example, the encoder may select the intra prediction mode to encode the current block based on a rate-distortion measure (e.g., Lagrangian rate-distortion cost) determined using the prediction errors. The encoder may send an indication of the selected intra prediction mode and its corresponding prediction error to a decoder for decoding of the current block.

Similar to an encoder, a decoder may predict the samples of a current block being decoded, such as current block 904, for an intra prediction mode as explained above. For example, the decoder may receive an indication of an angular intra prediction mode from an encoder for a block. The decoder may construct a set of reference samples and perform intra prediction based on the angular intra prediction mode indicated by the encoder for the block in a similar manner as discussed above for the encoder. The decoder would add the predicted values of the samples of the block to a residual of the block to reconstruct the block. In another embodiment, the decoder may not receive an indication of an angular intra prediction mode from an encoder for a block. Instead, the decoder may determine an intra prediction mode through other, decoder-side means.

Although the description above was primarily made with respect to intra prediction modes in HEVC and VVC, it will be understood that the techniques of the present disclosure described above and further below may be applied to other intra prediction modes, including those of other video coding standards like VP8, VP9, AV1, and the like.

As explained above, intra prediction may exploit correlations between spatially neighboring samples in the same picture of a video sequence to perform video compression. Inter prediction is another coding tool that may be used to exploit correlations in the time domain between blocks of samples in different pictures of the video sequence to perform video compression. In general, an object may be seen across multiple pictures of a video sequence. The object may move (e.g., by some translation and/or affine motion) or remain stationary across the multiple pictures. A current block of samples in a current picture being encoded may therefore have a corresponding block of samples in a previously decoded picture that accurately predicts the current block of samples. The corresponding block of samples may be displaced from the current block of samples due to movement of an object, represented in both blocks, across the respective pictures of the blocks. The previously decoded picture may be referred to as a reference picture and the corresponding block of samples in the reference picture may be referred to as a reference block or motion compensated prediction. An encoder may use a block matching technique to estimate the displacement (or motion) and determine the reference block in the reference picture.

Similar to intra prediction, once a prediction for a current block is determined and/or generated using inter prediction, an encoder may determine a difference between the current block and the prediction. The difference may be referred to as a prediction error or residual. The encoder may then store and/or signal in a bitstream the prediction error and other related prediction information for decoding or other forms of consumption. A decoder may decode the current block by predicting the samples of the current block using the prediction information and combining the predicted samples with the prediction error.

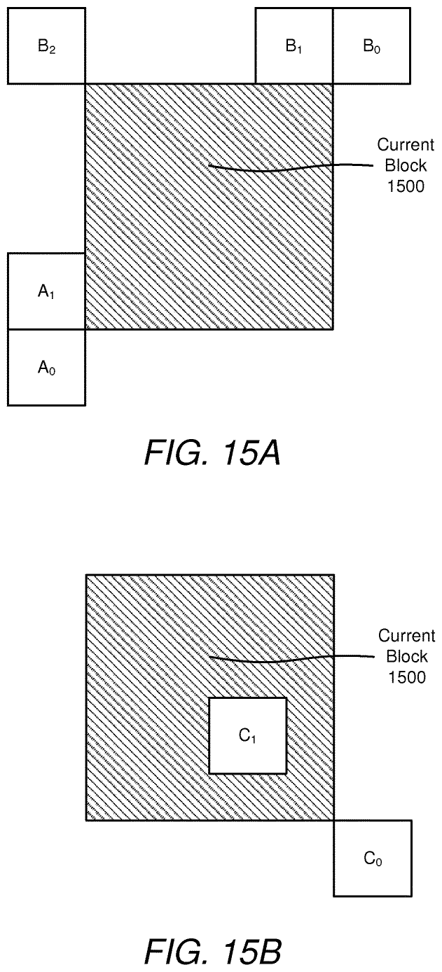

FIG. 13A illustrates an example of inter prediction performed for a current block 1300 in a current picture 1302 being encoded. An encoder, such as encoder 200 in FIG. 2, may perform inter prediction to determine and/or generate a reference block 1304 in a reference picture 1306 to predict current block 1300. Reference pictures, like reference picture 1306, are prior decoded pictures available at the encoder and decoder. Availability of a prior decoded picture may depend on whether the prior decoded picture is available in a decoded picture buffer at the time current block 1300 is being encoded or decoded. The encoder may, for example, search one or more reference pictures for a reference block that is similar to current block 1300. The encoder may determine a “best matching” reference block from the blocks tested during the searching process as reference block 1304. The encoder may determine that reference block 1304 is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), or sum of absolute transformed differences (SATD)) between the prediction samples of reference block 1304 and the original samples of current block 1300.

The encoder may search for reference block 1304 within a search range 1308. Search range 1308 may be positioned around the collocated position (or block) 1310 of current block 1300 in reference picture 1306. In some instances, search range 1308 may at least partially extend outside of reference picture 1306. When extending outside of reference picture 1306, constant boundary extension may be used such that the values of the samples in the row or column of reference picture 1306, immediately adjacent to the portion of search range 1308 extending outside of reference picture 1306, are used for the “sample” locations outside of reference picture 1306. All or a subset of potential positions within search range 1308 may be searched for reference block 1304. The encoder may utilize any one of a number of different search implementations to determine and/or generate reference block 1304. For example, the encoder may determine a set of a candidate search positions based on motion information of neighboring blocks to current block 1300.

One or more reference pictures may be searched by the encoder during inter prediction to determine and/or generate the best matching reference block. The reference pictures searched by the encoder may be included in one or more reference picture lists. For example, in HEVC and VVC, two reference picture lists may be used, a reference picture list 0 and a reference picture list 1. A reference picture list may include one or more pictures. Reference picture 1306 of reference block 1304 may be indicated by a reference index pointing into a reference picture list comprising reference picture 1306.

The displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. FIG. 13B illustrates the horizontal component and vertical component of motion vector 1312. A motion vector, such as motion vector 1312, may have fractional or integer resolution. A motion vector with fractional resolution may point between two samples in a reference picture to provide a better estimation of the motion of current block 1300. For example, a motion vector may have ½, ¼, ⅛, 1/16, or 1/32 fractional sample resolution. When a motion vector points to a non-integer sample value in the reference picture, interpolation between samples at integer positions may be used to generate the reference block and its corresponding samples at fractional positions. The interpolation may be performed by a filter with two or more taps.

Once reference block 1304 is determined and/or generated for current block 1300 using inter prediction, the encoder may determine a difference (e.g., a corresponding sample-by-sample difference) between reference block 1304 and current block 1300. The difference may be referred to as a prediction error or residual. The encoder may then store and/or signal in a bitstream the prediction error and the related motion information for decoding or other forms of consumption. The motion information may include motion vector 1312 and a reference index pointing into a reference picture list comprising reference picture 1306. In other instances, the motion information may include an indication of motion vector 1312 and an indication of the reference index pointing into the reference picture list comprising reference picture 1306. A decoder may decode current block 1300 by determining and/or generating reference block 1304, which forms the prediction of current block 1300, using the motion information and combining the prediction with the prediction error.

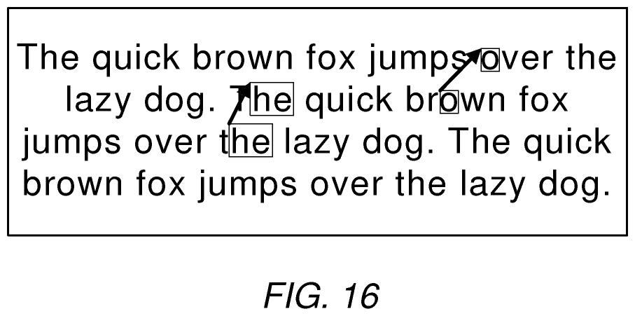

In FIG. 13A, inter prediction is performed using one reference picture 1306 as the source of the prediction for current block 1300. Because the prediction for current block 1300 comes from a single picture, this type of inter prediction is referred to as uni-prediction. FIG. 14 illustrates another type of inter prediction, referred to as bi-prediction, performed for a current block 1400. In bi-prediction, the source of the prediction for a current block 1400 comes from two pictures. Bi-prediction may be useful, for example, where the video sequence comprises fast motion, camera panning or zooming, or scene changes. Bi-prediction may also be useful to capture fade outs of one scene or fade outs from one scene to another, where two pictures are effectively displayed simultaneously with different levels of intensity.

Whether uni-prediction or both uni-prediction and bi-prediction are available for performing inter prediction may depend on a slice type of current block 1400. For P slices, only uni-prediction may be available for performing inter prediction. For B slices, either uni-prediction or bi-prediction may be used. When uni-prediction is performed, an encoder may determine and/or generate a reference block for predicting current block 1400 from reference picture list 0. When bi-prediction is performed, an encoder may determine and/or generate a first reference block for predicting current block 1400 from reference picture list 0 and determine and/or generate a second reference block for predicting current block 1400 from reference picture list 1.

In FIG. 14, inter-prediction is performed using bi-prediction, where two reference blocks 1402 and 1404 are used to predict current block 1400. Reference block 1402 may be in a reference picture of one of reference picture list 0 or 1, and reference block 1404 may be in a reference picture of the other one of reference picture list 0 or 1. As shown in FIG. 14, reference block 1402 is in a picture that precedes the current picture of current block 1400 in terms of picture order count (POC), and reference block 1404 is in a picture that proceeds the current picture of current block 1400 in terms of POC. In other examples, the reference pictures may both precede or proceed the current picture in terms of POC. POC is the order in which pictures are output from, for example, a decoded picture buffer and is the order in which pictures are generally intended to be displayed. However, it should be noted that pictures that are output are not necessarily displayed but may undergo different processing or consumption, such as transcoding. In other examples, the two reference blocks determined and/or generated using bi-prediction may come from the same reference picture. In such an instance, the reference picture may be included in both reference picture list 0 and reference picture list 1.

A configurable weight and offset value may be applied to the one or more inter prediction reference blocks. An encoder may enable the use of weighted prediction using a flag in a picture parameter set (PPS) and signal the weighting and offset parameters in the slice segment header for the current block. Different weight and offset parameters may be signaled for luma and chroma components.

Once reference blocks 1402 and 1404 are determined and/or generated for current block 1400 using inter prediction, the encoder may determine a difference between current block 1400 and each of reference blocks 1402 and 1404. The differences may be referred to as prediction errors or residuals. The encoder may then store and/or signal in a bitstream the prediction errors and their respective related motion information for decoding or other forms of consumption. The motion information for reference block 1402 may include motion vector 1406 and the reference index, into the reference picture list, of the reference picture comprising reference block 1402. In other instances, the motion information for reference block 1402 may include an indication of motion vector 1406 and an indication of the reference index, into the reference picture list, of the reference picture comprising reference block 1402. The motion information for reference block 1404 may include motion vector 1408 and the reference index, into the reference picture list, of the reference picture comprising reference block 1404. In other instances, the motion information for reference block 1404 may include an indication of motion vector 1408 and an indication of the reference index, into the reference picture list, of the reference picture comprising reference block 1404. A decoder may decode current block 1400 by determining and/or generating reference blocks 1402 and 1404, which together form the prediction of current block 1400, using their respective motion information and combining the predictions with the prediction errors.

In HEVC, VVC, and other video compression schemes, motion information may be predictively coded before being stored or signaled in a bitstream. The motion information for a current block may be predictively coded based on the motion information of neighboring blocks of the current block. In general, the motion information of the neighboring blocks is often correlated with the motion information of the current block because the motion of an object represented in the current block is often the same or similar to the motion of objects in the neighboring blocks. Two of the motion information prediction techniques in HEVC and VVC include advanced motion vector prediction (AMVP) and inter prediction block merging.

An encoder, such as encoder 200 in FIG. 2, may code a motion vector using the AMVP tool as a difference between the motion vector of a current block being coded and a motion vector predictor (MVP). An encoder may select the MVP from a list of candidate MVPs. The candidate MVPs may come from previously decoded motion vectors of neighboring blocks in the current picture of the current block or blocks at or near the collocated position of the current block in other reference pictures. Both the encoder and decoder may generate or determine the list of candidate MVPs.

After the encoder selects an MVP from the list of candidate MVPs, the encoder may signal, in a bitstream, an indication of the selected MVP and a motion vector difference (MVD). The encoder may indicate the selected MVP in the bitstream by an index pointing into the list of candidate MVPs. The MVD may be calculated based on the difference between the motion vector of the current block and the selected MVP. For example, for a motion vector represented by a horizontal component (MVx) and a vertical displacement (MVy) relative to the position of the current block being coded, the MVD may be represented by two components calculated as follows:

MVDₓ=MVₓ−MVPₓ (15)

MVD_{y}=MV_{y}−MVP_{y} (16)

where MVDₓ and MVD_{y} respectively represent the horizontal and vertical components of the MVD, and MVPₓ and MVP_{y} respectively represent the horizontal and vertical components of the MVP. A decoder, such as decoder 300 in FIG. 3, may decode the motion vector by adding the MVD to the MVP indicated in the bitstream. The decoder may then decode the current block by determining and/or generating the reference block, which forms the prediction of the current block, using the decoded motion vector and combining the prediction with the prediction error.

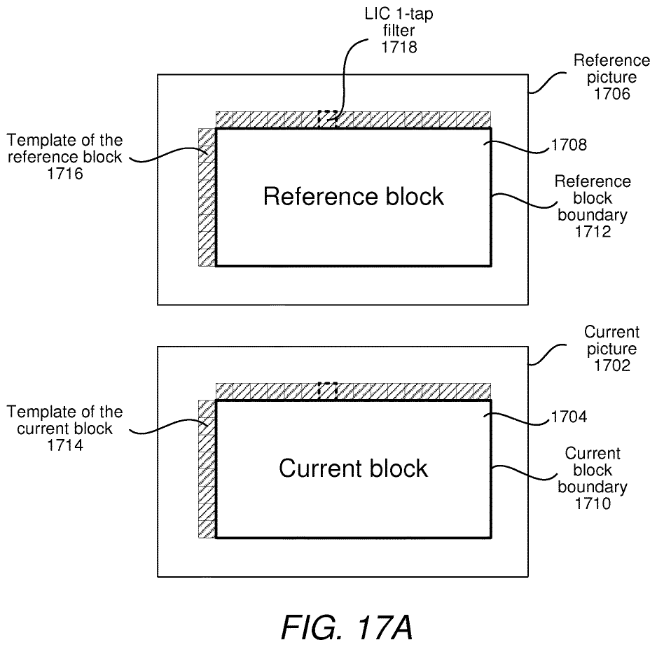

In HEVC and VVC, the list of candidate MVPs for AMVP may comprise two candidates referred to as candidates A and B. Candidates A and B may include up to two spatial candidate MVPs derived from five spatial neighboring blocks of the current block being coded, one temporal candidate MVP derived from two temporal, co-located blocks when both spatial candidate MVPs are not available or are identical, or zero motion vectors when the spatial, temporal, or both candidates are not available. FIG. 15A illustrates the location of the five spatial candidate neighboring blocks relative to a current block 1500 being encoded. The five spatial candidate neighboring blocks are respectively denoted A₀, A₁, B₀, B₁, and B₂. FIG. 15B illustrates the location of the two temporal, co-located blocks relative to current block 1500 being coded. The two temporal, co-located blocks are denoted C₀ and C₁ and are included in a reference picture that is different from the current picture of current block 1500.

An encoder, such as encoder 200 in FIG. 2, may code a motion vector using the inter prediction block merging tool also referred to as merge mode. Using merge mode, the encoder may reuse the same motion information of a neighboring block for inter prediction of a current block. Because the same motion information of a neighboring block is used, no MVD needs to be signaled and the signaling overhead for signaling the motion information of the current block may be small in size. Similar to AMVP, both the encoder and decoder may generate a candidate list of motion information from neighboring blocks of the current block. The encoder may then determine to use (or inherit) the motion information of one neighboring block's motion information in the candidate list for predicting the motion information of the current block being coded. The encoder may signal, in the bitstream, an indication of the determined motion information from the candidate list. For example, the encoder may signal an index pointing into the list of candidate motion information to indicate the determined motion information.

In HEVC and VVC, the list of candidate motion information for merge mode may comprise up to four spatial merge candidates that are derived from the five spatial neighboring blocks used in AMVP as shown in FIG. 15A, one temporal merge candidate derived from two temporal, co-located blocks used in AMVP as shown in FIG. 15B, and additional merge candidates including bi-predictive candidates and zero motion vector candidates.

It should be noted that inter prediction may be performed in other ways and variants than those described above. For example, motion information prediction techniques other than AMVP and merge mode are possible. In addition, although the description above was primarily made with respect to inter prediction modes in HEVC and VVC, it will be understood that the techniques of the present disclosure described above and further below may be applied to other inter prediction modes, including those of other video coding standards like VP8, VP9, AV1, and the like. In addition, history based motion vector prediction (HMVP), combined intra/inter prediction mode (CIIP), and merge mode with motion vector difference (MMVD) as described in VVC may also be performed and are within the scope of the present disclosure.

In inter prediction, a block matching technique may be applied to determine a reference block in a different picture than the current block being encoded. Block matching techniques have also been applied to determine a reference block in the same picture as a current block being encoded. However, it has been determined that for camera-captured videos, a reference block in the same picture as the current block determined using block matching may often not accurately predict the current block. For screen content video this is generally not the case. Screen content video may include, for example, computer generated text, graphics, and animation. Within screen content, there is often repeated patterns (e.g., repeated patterns of text and graphics) within the same picture. Therefore, a block matching technique applied to determine a reference block in the same picture as a current block being encoded may provide efficient compression for screen content video.

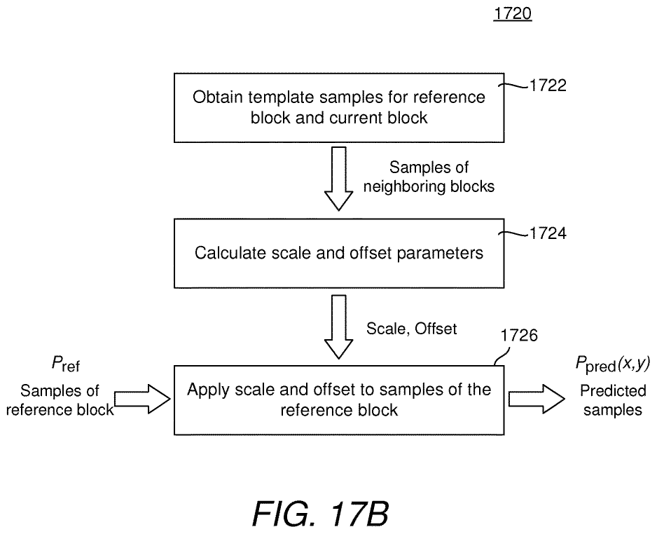

HEVC and VVC both include a prediction technique to exploit the correlation between blocks of samples within the same picture of screen content video. This technique is referred to as intra block copy (IBC) or current picture referencing (CPR). Similar to inter prediction, an encoder may apply a block matching technique to determine a displacement vector (referred to as a block vector (BV) that indicates the relative displacement from the current block to a reference block (or intra block compensated prediction) that “best matches” the current block. The encoder may determine the best matching reference block from blocks tested during a searching process similar to inter prediction. The encoder may determine that a reference block is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), sum of absolute transformed differences (SATD), or difference determined based on a hash function) between the prediction samples of the reference block and the original samples of the current block. A reference block may correspond to prior decoded blocks of samples of the current picture. The reference block may comprise decoded blocks of samples of the current picture prior to being processed by in-loop filtering operations, like deblocking or SAO filtering. FIG. 16 illustrates an example of IBC applied for screen content. The rectangular portions with arrows beginning at their boundaries are current blocks being encoded and the rectangular portions that the arrows point to are the reference blocks for predicting the current blocks.

Once a reference block is determined and/or generated for a current block using IBC, the encoder may determine a difference (e.g., a corresponding sample-by-sample difference) between the reference block and the current block. The difference may be referred to as a prediction error or residual. The encoder may then store and/or signal in a bitstream the prediction error and the related prediction information for decoding or other forms of consumption. The prediction information may include a BV. In other instances, the prediction information may include an indication of the BV. A decoder, such as decoder 300 in FIG. 3, may decode the current block by determining and/or generating the reference block, which forms the prediction of the current block, using the prediction information and combining the prediction with the prediction error.

In HEVC, VVC, and other video compression schemes, a BV may be predictively coded before being stored or signaled in a bitstream. The BV for a current block may be predictively coded based on the BV of neighboring blocks of the current block. For example, an encoder may predictively code a BV using the merge mode as explained above for inter prediction or a similar technique as AMVP also explained above for inter prediction. The technique similar to AMVP may be referred to as BV prediction and difference coding.

For BV prediction and difference coding, an encoder, such as encoder 200 in FIG. 2, may code a BV as a difference between the BV of a current block being coded and a BV predictor (BVP). An encoder may select the BVP from a list of candidate BVPs. The candidate BVPs may come from previously decoded BVs of neighboring blocks of the current block in the current picture. Both the encoder and decoder may generate or determine the list of candidate BVPs.

After the encoder selects a BVP from the list of candidate BVPs, the encoder may signal, in a bitstream, an indication of the selected BVP and a BV difference (BVD). The encoder may indicate the selected BVP in the bitstream by an index pointing into the list of candidate BVPs. The BVD may be calculated based on the difference between the BV of the current block and the selected BVP. For example, for a BV represented by a horizontal component (BVₓ) and a vertical component (BV_{y}) relative to the position of the current block being coded, the BVD may be represented by two components calculated as follows:

BVDₓ=BVₓ−BVPₓ (17)

BVD_{y}=BV_{y}−BVP_{y} (18)

where BVDₓ and BVD_{y} respectively represent the horizontal and vertical components of the BVD, and BVPₓ and BVP_{y} respectively represent the horizontal and vertical components of the BVP. A decoder, such as decoder 300 in FIG. 3, may decode the BV by adding the BVD to the BVP indicated in the bitstream. The decoder may then decode the current block by determining and/or generating the reference block, which forms the prediction of the current block, using the decoded BV and combining the prediction with the prediction error.

In HEVC and VVC, the list of candidate BVPs may comprise two candidates referred to as candidates A and B. Candidates A and B may include up to two spatial candidate BVPs derived from five spatial neighboring blocks of the current block being encoded, or one or more of the last two coded BVs when spatial neighboring candidates are not available (e.g., because they are coded in intra or inter mode). The location of the five spatial candidate neighboring blocks relative to a current block being encoded using IBC are the same as those shown in FIG. 15A for inter prediction. The five spatial candidate neighboring blocks are respectively denoted A₀, A₁, B₀, B₁, and B₂.

Local illumination compensation (LIC) is a prediction technique proposed for improving motion compensation in VVC. LIC models illumination variation between a current block and its reference block as a function of that between a current block template and a reference block template. The parameters of the LIC function are denoted by a scale α and an offset (bias) β, to form the linear equation (19) (shown below) that is used to compensate illumination variations in the reference block. P_{ref} is a sample (e.g., a reference sample) in the reference block pointed to by a motion vector (MV) in inter prediction (or a displacement vector in intra prediction).

P_{pred}=α*P_{ref}−β (19)

The parameters α and β are derived based on a template associated with the current block (referred to as current block template or current template) and a corresponding template associated with the reference block (referred to as reference block template or reference template). Consequently, LIC incurs no additional signaling overhead, other than for an LIC flag that may be signaled to indicate the use of LIC.

The application of LIC to the reference block associated with a current block comprises adjusting reference samples by multiplying the reference samples (respectively the values of the samples) with α (respectively with a value of α) and adding β (respectively a value of β) in accordance with the above-described linear equation for compensating for local illumination differences. The parameters α and β are derived from samples in the templates of the current block and the reference block using, for example, a least mean squares method. The parameters α and β can be derived using all, a subset, or subsets of samples in the templates.

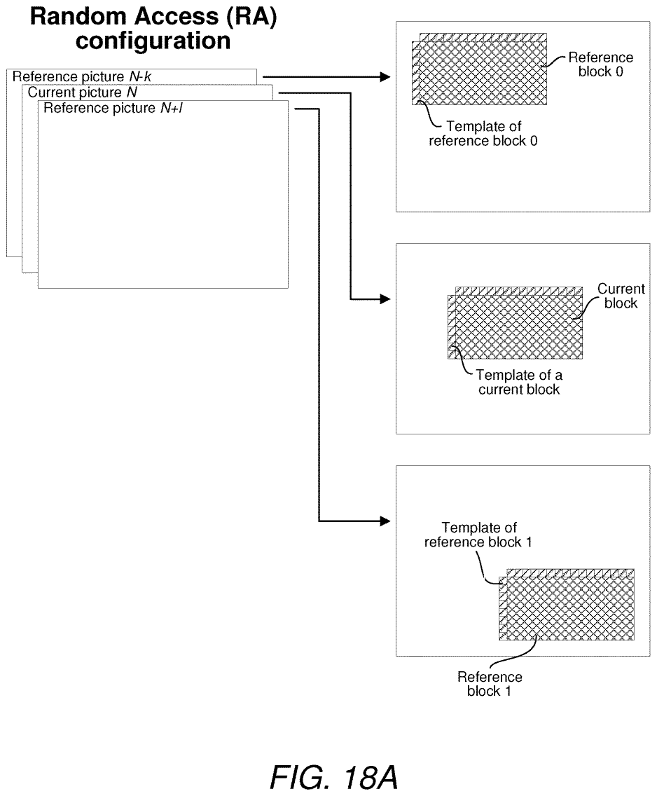

FIG. 17A shows a current block and a reference block with their corresponding templates that are used in determining α and β for LIC for inter prediction. A current block 1704 is shown in a current picture 1702 and a reference block 1708 is shown in a reference picture 1706. In an example sequence of pictures, the current block 1704 may correspond to the current block 1400 shown in FIG. 14 and the reference block 1708 may correspond to either reference block 1402 or reference block 1404. Corresponding templates 1714 and 1716 are shown in relation to the current block 1704 and reference block 1708, respectively. The current template 1714 comprises neighboring samples adjacent to the current block boundary (current block border) 1710 at the left edge and the top edge of the current block 1704. The length of the current template 1714 is the sum of the lengths of the left column and the top row of samples in the current block 1704. The reference template 1716 comprises neighboring samples adjacent to the reference block boundary (reference block border) 1712 at the left edge and the top edge of the reference block 1708. The length of the reference template 1716 is the sum of the lengths of the left column and the top row of samples in the reference block 1708. In the illustrated example, the templates 1714 and 1716 have a height of 1 sample (i.e., the left portion of each template 1714 and 1716 is a single column of samples, and the top portion of each template 1714 and 1716 is a single row of samples).

The scale parameter, α, can be determined by:

$$scale = \frac{n \sum {T}_{ref} ( i ) {T}_{rec} ( i ) - \sum {T}_{ref} ( i ) \sum {T}_{rec} ( i )}{n \sum {T}_{ref}^{2} ( i ) - {( \sum {T}_{ref} ( i ) )}^{2}} . \qquad ( 20 )$$

The offset parameter, β, can be determined by

$$offset = \frac{\sum {T}_{rec} ( i ) - scale \cdot \sum {T}_{ref} ( i )}{n} . \qquad ( 21 )$$

In the above two equations (20) and (21), n is the number of samples, T_{rec}(i) is the i^{th} sample of the current template (as noted above, the current template is the template of the current block), and T_{ref}(i) is the i^{th} sample of the reference template (as noted above, the reference template is the template of the reference block). The current block may also be referred to as the predicted block, the reconstructed block, or the block to be predicted. It will be noted that when the current block 1704 is yet to be reconstructed, the neighboring blocks (to which the samples of the current template 1714 belong) adjacent to the left edge and the top edge of the current block 1704 have been reconstructed.

FIG. 17B shows a process 1720 to calculate a predicted block when performing inter prediction using LIC.

At operation 1722, template samples for the current block and the reference block are obtained. LIC uses a one-tap filter 1718 to sample templates 1714 and 1716. The one-tap filter 1718 is used to obtain each respective template sample i from the same relative position in the two templates 1714 and 1716.

At operation 1724, the template samples (e.g., neighbor samples of the reference block and the current block) are used in the equation (20) to calculate the scale parameter. In some implementations, as shown above, the offset parameter is calculated using the calculated scale parameter.

After scale α and offset β parameters are determined by applying the one-tap filter 1718 to the current template 1714 and the reference template 1716, at operation 1726, they (i.e., scale α and offset β) are applied to respective reference samples P_{ref} to obtain prediction samples P_{pred} (samples of the prediction block) in accordance with the equation (19) shown above.

The thus determined predicted block may be subtracted from the current block to obtain the prediction errors (residuals) that are subsequently encoded in a bitstream. The predicted block determined based on LIC may have improved illumination variation relative to the reference block, and may consequently yield smaller prediction errors that need to be encoded.

LIC is described for inter prediction in the Enhanced Compression Model (ECM) software algorithm that is currently under coordinated exploration study by the Joint Video Exploration Team (JVET) of ITU-T Video Coding Experts Group (VCEG) and ISO/IEC MPEG as potential enhanced video coding technology beyond the capabilities of VVC.

Bidirectional prediction, sometimes referred to as “bi-prediction,” has been in use for inter prediction for some time and is described above in relation to FIG. 14 among others. As one of the primary methods in the conventional inter prediction of video coding, bi-prediction can improve the coding efficiency when compared with uni-prediction. In general, it can generate a better predicted block from both forward and backward prediction blocks than a uni-prediction block, except for scene change or illumination change. Conventional bi-prediction assigns equal weights to each of the reference blocks when predicting the current block.

VVC adopted bi-prediction with coding unit (CU)-level weight (BCW) as one of the tools which enhanced the coding efficiency of conventional bi-prediction by assigning different weights to the two prediction blocks in the process of inter prediction. BCW (also known as generalized bi-prediction (GBi) is thus a weighted bi-prediction technique for predicting a block by weighted-averaging two motion-compensated blocks. BCW extends the notion of weighted bi-prediction to the CU level allowing bi-prediction weights to be determined per CU. The determined bi-prediction weights are applied to bi-prediction PUs, across all color components, to bi-predict the CU.

In conventional BCW, a list of pre-defined candidate weights is used. At the encoder, one of the pre-defined candidate weights is selected as a BCW weight for a bi-predicted CU. For a non-merge coded CU (a CU for which merge mode is not used to code the motion vector), a BCW index associated with the selected BCW weight is signaled to the decoder. The BCW index points to the entry of the selected BCW weight in the list of pre-defined candidate weights. For a merge coded CU, the BCW index is inherited from neighboring blocks based on a signaled merge candidate index. The merge candidate index points to a merge candidate of the merge coded CU.

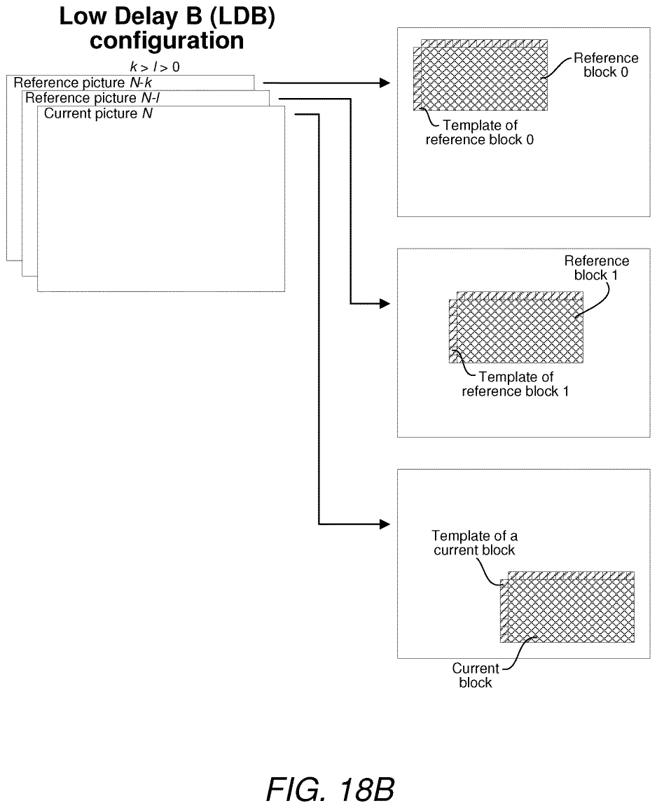

Generally, for non-low delay pictures (e.g., where reference picture list 0 corresponds to pictures that precede the current picture and reference picture list 1 corresponds to pictures that follow the current picture in terms of POC, see FIG. 18A), the list of pre-defined candidate weights may include {− 2/8, ⅜, 4/8, ⅝, and 10/8}. For low delay pictures (e.g., where both reference picture list 0 and reference picture list 1 correspond to pictures that precede the current picture, see FIG. 18B), the list may be reduced to {⅜, 4/8, and ⅝}. The different weights between the two uni-prediction blocks are used to adaptively highlight either the forward or backward predicted block. In ECM-9.0, BCW is applied to a bi-predicted CU.

An index, referred to as the “BCW index,” is used to identify the weights for the current block. The BCW index is signaled for non-merge coded CUs, whereas for merge coded CUs, the BCW index is inherited from neighboring blocks according to the signaled merge candidate index. Note that BCW weights are applied to each color plane belonging to a given CU, i.e., to luma and both chroma blocks.

The current block can be calculated in accordance with the AMVP mode or merge mode. As described above, in AMVP mode, the reference block is determined at the encoder and is signaled to the decoder whereas in the merge mode the reference block (from which the BCW index is inherited) is selected from among neighbors of the current block, in accordance with an index signaled from the encoder.

In some implementations, BCW can be enhanced using the merge mode. For example, the BCW index may be derived for merge coded CUs based on template matching cost. More particularly, the technique proposes to derive the BCW weight, for merge coded CUs, based on the list of pre-defined candidate weights using template matching (TM) cost. Given an inherited BCW weight, the technique proposes adjusting the BCW weight based on the list of pre-defined candidate weights. Specifically, the technique compares the BCW weight with one or more neighboring weights in the list of pre-defined candidate weights, based on TM cost. For example, if the BCW weight corresponds to the value 4/8 from the list {⅜, 4/8, and ⅝}, the technique proposes comparing the weight ⅜ with the weights 4/8 and ⅝ based on TM cost. Since the inherited BCW index is likely to have higher accuracy than another BCW index, the TM cost of the inherited BCW index is multiplied with 0.90625, that is, the cost is reduced by 3/32. Besides, the TM cost of the equal weight is multiplied with 0.90625 since bi-predicted samples are beneficial for bi-directional optical flow (BDOF) and BDOF is only applied to CU with equal weight. The TM cost for a BCW weight is calculated based on templates (neighboring reconstructed samples) of the current block and the reference blocks obtained respectively from reference picture list 0 and reference picture list 1. The weight with the minimum TM cost is selected as the BCW weight for the BCW prediction.

In some implementations, conventional LIC design can be extended to bi-predicted CUs. Specifically, when applying the proposed implementation to one bi-predicted current block, two different linear models are derived to compensate the illumination changes that exist between the current block and its two prediction blocks. Then, the final bi-prediction of the current block is calculated as the combination of two uni-prediction blocks after the LIC adjustment, i.e., as shown in equation (22) below:

P′[x,y]=(1−ω)·p₀′[x,y]+ω·p₁′[x,y] (22)

and

p₀′[x,y]=α₀·P₀[x,y]+β₀

p₁′[x,y]=α₁·P₁[x,y]+β₁
where α₀ and β₀, and α₁ and β₁ represent the scales and the offsets in reference picture list 0 (L0) and reference picture list 1 (11), respectively; ω indicates the weight (as indicated by the CU-level BCW index) that is applied when combining the two uni-prediction blocks. Similar to the conventional LIC design, one control flag is signaled for AMVP bi-predicted CUs to indicate the enabling/disabling of the LIC, while the control flag is inherited from one neighboring block for merge inter CUs (including AMVP-Merge mode). Additionally, LIC is disabled when decoder-side motion vector refinement (DMVR) (including multi-pass DMVR, adaptive DMVR and affine DMVR) and bi-directional optical flow (BDOF) is applied.

To reuse the linear model derivation of the conventional LIC, one iterative approach is applied to alternately derive the L0 and L1 linear models. Specifically, given the two MVs of the current block, the iterative approach assumes T₀ (e.g., template of block 0 in FIGS. 18A-18B) and T₁ (e.g., template of block 1 in FIGS. 18A-18B) are the two predictions of the current block's template T. The method first derives the L0 linear model (α₀ and β₀) that results in the minimum difference between T₀ and T; Then, the L1 linear model (α₁ and β₁) can be calculated that minimizes the difference between T₁, and the updated template. Finally, the L0 linear model is refined again in the same manner.

In some embodiments, the following two changes are applied to better handle the interaction between the LIC and the overlapped block motion compensation (OBMC): it is proposed to enable the OBMC to the inter blocks where the LIC is applied. Additionally, to achieve a better complexity/performance trade-off, the OBMC is only applied for refining the prediction samples on the top and left boundaries of one LIC CU while the OBMC on the internal sub-block boundaries are always disabled. Besides the MVs, it is proposed to also take the LIC parameters of one neighboring block (when it is coded by the LIC) into consideration when generating its corresponding prediction samples for the OBMC of the current CU.

Illumination variations in reference blocks sometimes cause large prediction errors. In addition to illumination variations, other types of artefacts and/or differences between a reference block and a current block (e.g., quantization or camera noise, a reference block being smoother than a current block) might further increase prediction errors. LIC was proposed to improve such variation in the predicted block. LIC was initially proposed for uni-prediction. More recently, LIC has been proposed for bi-prediction too. However, the proposed application of LIC to bi-prediction may be improved.

More particularly, in the existing technology, LIC and multiparametric filtering are performed for each of the L0 and L1 bi-prediction reference blocks of a current block separately. Therefore, the similarity of each reference block to a current block is estimated independently from each other. That can, however, lead to deriving suboptimal model parameters and, therefore, lower compression performance.

Embodiments of the present disclosure are related to an approach for multiparametric filtering in inter prediction that can provide more optimal model parameters by deriving the model parameters jointly for the multiple reference blocks of the current block. For example, in bi-predictive inter prediction of a current block, the model parameters for the L0 and L1 reference blocks are derived jointly. In some embodiments, improved model parameters provide for improved illumination compensation of the reference blocks and thus may yield better compression performance. These and other features of the present disclosure are described further below.

In some embodiments, as noted above, LIC can be implemented for bi-predictive inter prediction. One proposed implementation calculates LIC model parameters (i.e., scale and bias) separately for each of L0 and L1 reference block of the current block being bi-directionally inter predicted. Another proposed implementation uses a single tap filter on the reference templates and current template for calculating the LIC model parameters.

As also noted above, independently or separately determining the LIC model parameters initially may lead to sub-optimal values being obtained for the LIC model parameters.

In some embodiments, instead of existing implementations, the model parameters for a muti-tap filter for a current block are jointly determined for the multiple reference blocks of the current block. For example, in bi-predictive inter prediction of the current block, the illumination compensation parameters such as scale and bias parameters of LIC are jointly calculated for the L0 and L1 reference blocks. The multi-tap filter may also be referred to as a multiparametric filter.

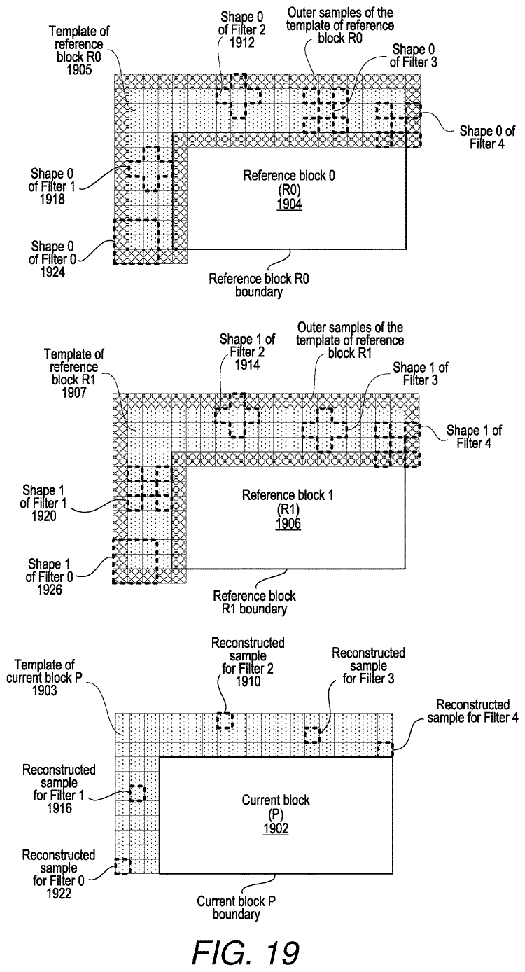

An idea behind the method according to embodiments is to split the multi-tap filter into M shapes (M split-shapes or M portions) so that each of the split-shapes is applied to a reference block from a respective corresponding reference frame of the current frame. Although the multi-tap filter is spatially split between 2 or more reference blocks, i.e. can have M spatially independent filter shapes as shown in FIG. 19, the process of deriving filter coefficients is unified in example embodiments. Mathematically expressed, a single system of linear equations (also referred to as a linear system) is used to derive filter coefficients for all the M split-shapes of the multi-tap filter.

The length L of the split-shape multi-tap filter is defined as the sum of the lengths lₘ of all the M filter shapes as shown in equation (23):

$$L = {\sum }_{m = 0}^{M - 1} {l}_{m} . \qquad ( 23 )$$

In the case of bidirectional prediction, since the number of reference frames is 2, M equals 2 (M=2).

FIG. 19 illustrates examples of a single multi-tap filter being split into 2 shapes with respect to reference blocks 1904 and 1906 of a current block 1902. The reconstructed sample 1910 of the multi-tap filter 2 in the template 1903 of the current block 1902 is predicted based on samples from its two corresponding split-shapes 1912 and 1914 applied to templates 1905 and 1907 of reference blocks 1904 and 1906 respectively. Thus, the length of the multi-tap filter used for reconstructing sample 1910 is 10, which is the sum of the lengths of the split-shapes 1912 and 1914 which are each a 5-tap filter. In this example, split-shapes 1912 and 1914 are of the same shape, of a “plus” sign, and of the same length (e.g., 5).

Embodiments of the present disclosure are not limited to multi-tap filters that have split-shapes of the same size and/or shape. Embodiments may include multi-tap filters that have split-shapes that are of same shape and same size, different shapes but of the same size, same shape but of different sizes, or different shapes and different sizes. Thus the M shapes of the split-filter can have the same shape for all reference pictures, a respectively different shape for each reference picture, or these shapes can be the same for some of the reference pictures and different of others of the reference pictures. FIG. 19 illustrates examples where split-shape filters have: a same shape for all reference blocks (Filter 0, Filter 2, and Filter 4); and different shapes for reference blocks (Filter 1 and Filter 3).

In FIG. 19, multi-tap filter 0, corresponding to the reconstructed sample 1922 in the current template 1903, is an eighteen-tap filter that consists of two square split-shapes 1924 and 1926 each of which has 9 taps. Multi-tap filter 1, corresponding to the reconstructed sample 1916 in the current template 1903, is a 10-tap filter that consists of two 5-tap split-shapes 1918 that has a “plus sign” shape and 1920 that has a “x” shape. Multi-tap filter 3 is a 10-tap filter that consists of two 5-tap split-shapes that has a “x” shape in reference template 1905 and a “plus-sign” shape in reference template 1907. Multi-tap filter 4 is a 10-tap filter that consists of two 5-tap split-shapes that are a “x” shape in each of the reference templates 1905 and 1907.

As shown in FIG. 19, the multi-tap filter, and therefore its corresponding split-shapes, are used to select samples from the reference templates of the reference blocks, but may have one or more samples obtained from the outer samples of the template of a reference block. Each reference template is immediately adjacent to the top row and the left column of the corresponding reference block, and may have a width of one or more samples. Correspondingly, a current template is immediately adjacent to the top row and the left column of the current block, and may have a width of one or more samples. In the illustrated example, each reference template and the current template have a length of 25 samples (the sum of 8 samples at left edge, 16 samples at top edge, 1) and a width of 3 samples.

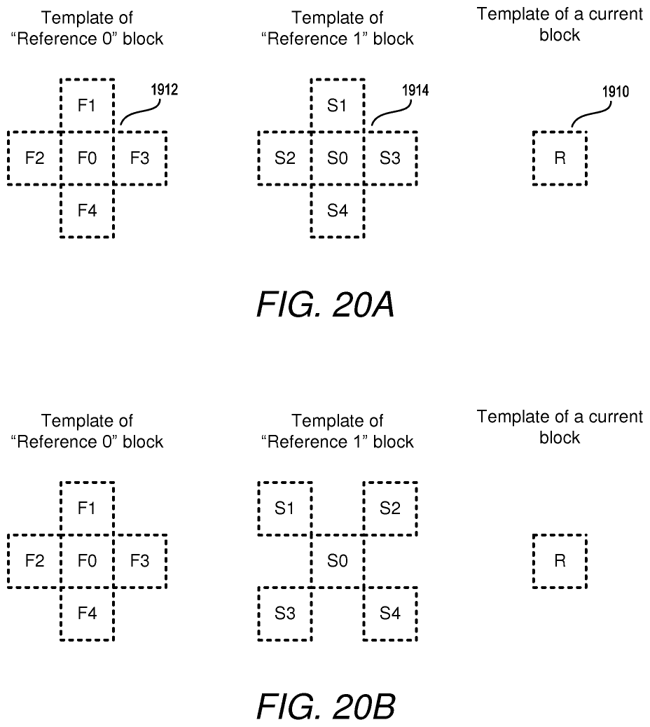

FIG. 20A and FIG. 20B illustrate example sample identifiers assigned to filter 2 and filter 1, respectively, in FIG. 19. Considering filter 2, the split-shape 1912 is used to obtain samples F0-F4 from template 1905 and split-shape 1914 is used to obtain samples S0-S4 from template 1907, in order to predict the reconstructed sample 1910. According to some embodiments, to derive coefficients of the multi-tap (multiparametric) split-shape filter, template samples corresponding to different taps of the mentioned split-shape filter and collected from different spatial locations of reference templates can be arranged in a single matrix as shown below. The matrix of input samples values obtained from templates of reference 0 (e.g., using split-shape 1912) and reference 1 (e.g., using split-shape 1914) shown in FIG. 20A for predicting samples 0 . . . (N−1), including sample 1910, of the current template 1903 may be defined as shown in equation (24):

$$[ \begin{matrix}F {0}_{0} & F {1}_{0} & F {2}_{0} & F {3}_{0} & F {4}_{0} & S {0}_{0} & S {1}_{0} & S {2}_{0} & S {3}_{0} & S {4}_{0} & {B}_{0} \\ F {0}_{1} & F {1}_{1} & F {2}_{1} & F {3}_{1} & F {4}_{1} & S {0}_{1} & S {1}_{1} & S {2}_{1} & S {3}_{1} & S {4}_{1} & {B}_{1} \\ … & … & … & … & … & … & … & … & … & … & … \\ F {0}_{i - 1} & F {1}_{i - 1} & F {2}_{i - 1} & F {3}_{i - 1} & F {4}_{i - 1} & S {0}_{i - 1} & S {1}_{i - 1} & S {2}_{i - 1} & S {3}_{i - 1} & S {4}_{i - 1} & {B}_{i - 1} \\ F {0}_{i} & F {1}_{i} & F {2}_{i} & F {3}_{i} & F {4}_{i} & S {0}_{i} & S {1}_{i} & S {2}_{i} & S {3}_{i} & S {4}_{i} & {B}_{i} \\ … & … & … & … & … & … & … & … & … & … & … \\ F {0}_{N - 2} & F {1}_{N - 2} & F {2}_{N - 2} & F {3}_{N - 2} & F {4}_{N - 2} & S {0}_{N - 2} & S {1}_{N - 2} & S {2}_{N - 2} & S {3}_{N - 2} & S {4}_{N - 2} & {B}_{N - 2} \\ F {0}_{N - 1} & F {1}_{N - 1} & F {2}_{N - 1} & F {3}_{N - 1} & F {4}_{N - 1} & S {0}_{N - 1} & S {1}_{N - 1} & S {2}_{N - 1} & S {3}_{N - 1} & S {4}_{N - 1} & {B}_{N - 1}\end{matrix} ] \qquad ( 24 )$$

In the example relating to the predicting of the current template 1903, the Fi_{y} in the matrix of linear equations (24) corresponds to the values of samples from the reference template 1905 in accordance with the filter positions i=0 . . . 4 of split-shape 1912 shown in FIG. 20A, for each filter center position y=0 . . . (N−1) corresponding to the sample being predicted in the current template. The Si_{y} in the matrix of linear equations (24) corresponds to the values of samples from the reference template 1907 in accordance with the filter positions i=0 . . . 4 of split-shape 1914 shown in FIG. 20A, for each filter center position y=0 . . . (N−1) corresponding to the sample being predicted in the current template.

The term B_{y}, y=0 . . . (N−1) in matrix (24) is a bias (offset) term. It is noted that since each shape of a split filter belongs to a different reference picture, each shape of the split filter can have its own bias term to compensate for illumination changes. However, another option (i.e. when only one bias term is used in the unified system of linear equations for all shapes of shape-split filter) is more preferable, at least in some embodiments, due to its lower computational complexity.

The matrix of input sample values 0 . . . (N−1) that spatially correspond to the central samples of different filter shapes at locations with indices 0 . . . (N−1) respectively, including sample 1910, taken from templates 1903 of the current block shown in FIG. 19 may be defined as in equation (25):

$$[ \begin{matrix}{R}_{0} \\ {R}_{1} \\ … \\ {R}_{i - 1} \\ {R}_{i} \\ … \\ {R}_{N - 2} \\ {R}_{N - 1}\end{matrix} ] . \qquad ( 25 )$$

In embodiments of the present disclosure, the two matrices (24) and (25) are processed as if all the samples were captured by a single multi-tap filter, i.e., one spatially connected shape of a filter, to derive filter coefficients. For example, in the example described above with respect to the multi-tap filter shown in FIG. 20A, the filter coefficients for filter positions F0-F4 and S0-S4 are calculated such that the difference between the predicted R₀-R_{(N-1)} and the actual values R₀-R_{(N-1)} from the current template is minimized.

The system of linear equations represented in the matrices (24) and (25) may be processed (e.g., solved) using a method such as, for example, the Gaussian method. Determinant (Cramer's) method, matrix method, etc. may be used as well. The main difference between the above mentioned methods in relation to solving the system of linear equations is in their computational complexity.

In example embodiments, the coefficients for multiple reference blocks when generating the prediction block are derived dependently (i.e., simultaneously) based on deriving the coefficients simultaneously from the current template and the reference templates of the reference blocks.

FIG. 20B illustrates an example of a split-shape filter with 2 different shapes applied to reference blocks. Since the overall number of filter coefficients is unchanged, matrices (24) and (25) are correct for the examples shown in FIG. 20B as well.

As noted above, the shapes and/or sizes of split-shapes of a multi-tap filter in example embodiments can be different. The difference in sizes can be due to, for example, quantization noise levels in reference frames if quantization was performed with different quantization parameters (QPs). For example, in the case of higher quantization noise levels, a larger size of split-shapes may be preferred in order to derive more reliable coefficient values.

In some embodiments, the interconnection between the respective split-shapes of a multi-tap filter, e.g., the first and second split-shapes of a bi-prediction multi-tap filter, may require changes in a motion estimation process (that is encoder-side only and, therefore, non-normative). A difference compared to the conventional motion estimation is that weights (coefficients) assigned to each sample of reference blocks may preferably be recalculated if at least one of the reference blocks is changed, and all the filter coefficients can require to be recalculated. This recalculation process may involve a significantly high amount of computations so that the motion estimation process becomes more computationally complex.

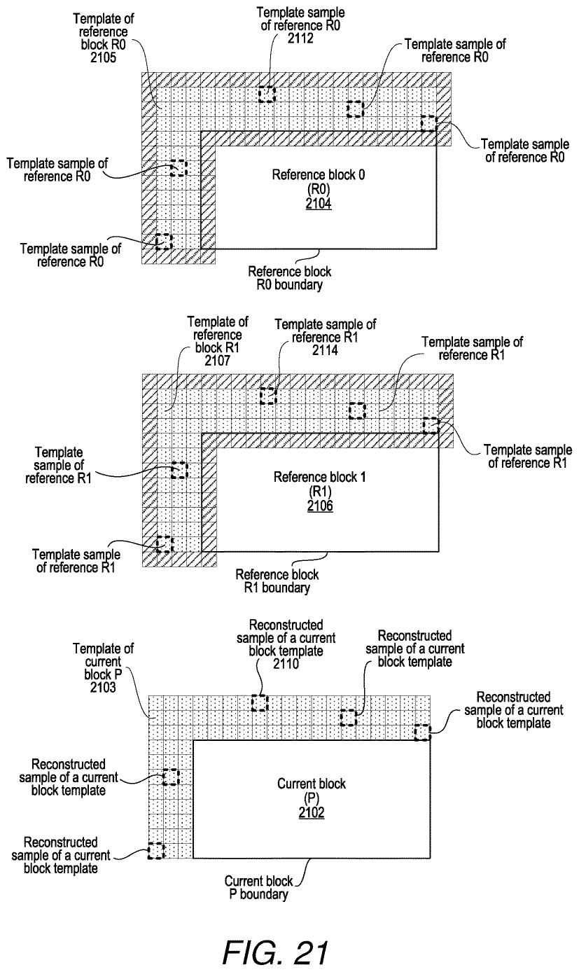

Therefore, in some embodiments, a less computationally complex process such as the Gram-Schmidt process (FIG. 21) or similar process, can be used (e.g., on the encoder-side) to get an approximation of the split-shape filtering process described in this disclosure. In particular, in some embodiments, the Gram-Schmidt process may be integrated into a video codec framework as one of the BCW modes that derives weights for a CU using its templates. Therefore, the integration of split-shape filter design into the video codec framework can be implemented as a set of BCW submodes, which includes: a Gram-Schmidt process (e.g., the simplest 2-tap filter, each tap of which is applied to different reference blocks); and higher-order split-shape filters that can be of various sizes with different shapes. With such a framework, the BCW prediction of the current block may be based on the higher-order split-shape multi-tap filters for more complex portions of a picture and the Gram-Schmidt process for less complex (e.g., smooth surfaces) portions of the picture.

In some embodiments, this set includes such BCW submodes, where multi-tap filter coefficients are derived from the templates, and is signaled as follows: a BCW index value indicates the entire set of these submodes; and a separate index is signaled to identify a particular submode (e.g., a submode corresponding to a higher-order model of split-shape filters or another submode for the derivation mechanism based on Gram-Schmidt process) belonging to the set.

In another embodiment, the split-shape multi-tap filter of this disclosure is integrated into a video coding framework comprising a submode of LIC (e.g., bi-predictive LIC) where switching between a bi-predictive LIC submode and split-shape filters is performed by signaling a flag or an index (e.g., to distinguish between several split-shape filters or several bi-predictive LIC submodes).

FIG. 21 illustrates an example two-tap filter of a Gram-Schmidt process, where the template of each of the two reference blocks has located in it one tap of the two-tap filter. According to the Gram-Schmidt process the filter coefficients are calculated by comparing, to respective samples (e.g., 2110) in the template 2103 of the current block 2102, the dot product of filter samples (e.g., 2112 and 2114) from the templates 2105 and 2107 of respective reference blocks 2104 and 2106.

The Gram-Schmidt process may proceed in three steps. The first step includes computing a first correlation between a first template of the first reference block (e.g., template 2105 of reference block 2104) and a second template of the second reference block (e.g., template 2107 of reference block 2106). As noted above, the template of a given block corresponds to samples of neighboring reconstructed blocks of the given block. In an embodiment, the first correlation between the first template and the second template corresponds to a dot product between the first and the second templates. In an embodiment, the dot product is computed by multiplying sample-by-sample the first template and the second template (samples of the first template are multiplied with respective samples, at corresponding positions, of the second template) and by summing the obtained products. In an embodiment, the dot product may be computed using successive multiply-accumulate operations.

The second step includes determining, based on the first correlation, a first weight for the first reference block and a second weight for the second reference block. The first correlation between the first template of the first reference block and the second template of the second reference block is a measure of similarity between the first reference block and the second reference block. The determination of the first and second weights based on the first correlation thus results in weights that take into account the similarity between the first reference block and the second reference block. For example, when the first reference block and the second reference block are highly similar, the first and second weights may have close values. Conversely, when the first reference block and the second reference block are highly dissimilar, the first and second weights may reflect this dissimilarity by having disparate values.

The third step in the Gram-Schmidt process includes determining a combined predictor of the current block based on the first and second weights. In an embodiment, the combined predictor corresponds to a weighted sum of the first template of the first reference block and the second template of the second reference block, based on the first and second weights. In an embodiment, the combined predictor is obtained by summing a product of the first template of the first reference block with the first weight and a product of the second template of the second reference block with the second weight. The combined predictor may then be used in the prediction of the current block.

The currently proposed split-shape filter for inter prediction, in some aspects, extends the above described Gram-Schmidt process applied to multiple-reference block. The proposed split-shape filter applies multi-parameter filter shapes (in contrast to a one-sample shape for Gram-Schmidt) and also each reference template (and subsequently reference blocks) may be applied a different multi-parameter filter shape.

Another embodiment encompasses the use-case when template samples are classified into different groups according to their properties. For example, samples might belong to edges, smooth regions, or transition areas between samples of the two previous types. In this design, different types of split-shape filters can be applied to different groups. These split-shape filters associated with different groups can differ in their lengths and shapes. In fact, these groups can be considered as independent groups and systems of linear equations can be separately constructed for them.

Example embodiments were described above using primarily the bi-prediction (e.g., BCW prediction). However, embodiments are not limited thereto. That is, the split-shape multi-tap filter can be used in other prediction techniques such as, for example, multi-hypotheses prediction where more than two reference blocks (e.g., 3-4 reference blocks) may be used to predict the current block and Combined Intra/Inter Prediction (CIIP).

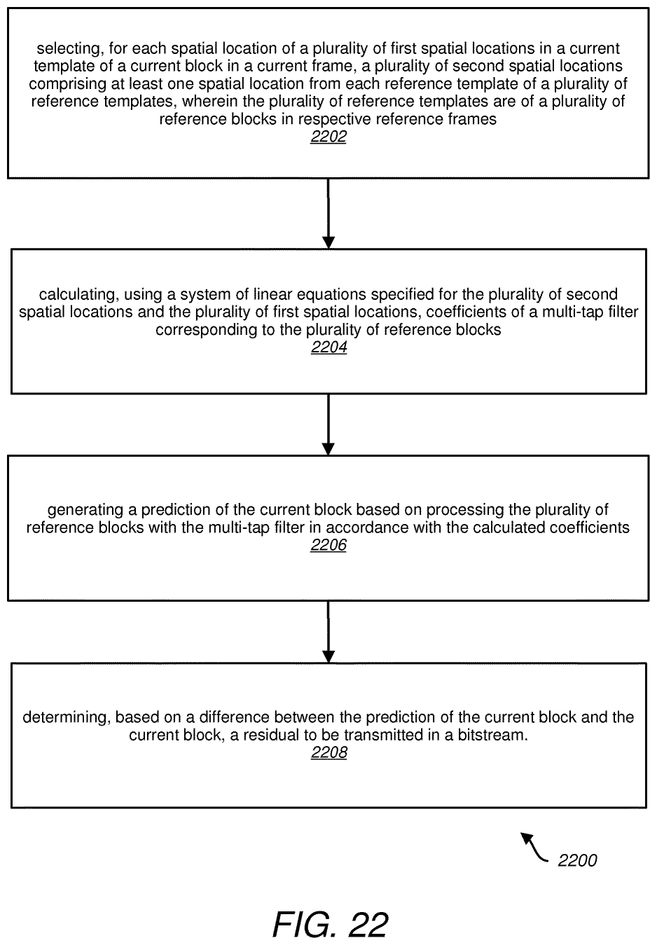

FIG. 22 illustrates a flowchart 2200 of an example method for applying split-shape multi-tap filtering to inter prediction in accordance with embodiments of the present disclosure. The method of flowchart 2200 may be implemented by an encoder, such as encoder 200 in FIG. 2.

The method of flowchart 2200 begins at 2202. At 2202, the encoder obtains a first plurality of template samples of a current block in a current picture and a second plurality of template samples of reference blocks in two or more reference pictures. For example, for each spatial location of a plurality of first spatial locations in the template of the current block in the current frame, a plurality of second spatial locations are selected from the reference templates. The plurality of second spatial locations comprise at least one spatial location from each reference template of a plurality of reference templates. The plurality of reference templates are of a plurality of reference blocks in respective reference frames.

In example embodiments, the second plurality of template samples of the reference blocks are obtained using respective portions of the split-shape multi-tap filter. The multi-tap filter is a linear filter, and in some embodiments, is a finite impulse response (FIR) filter.

The term “portion” of the split-shape multi-tap filter, as used herein, refers to one split shape of the multi-tap filter's plurality of split shapes. For each spatial location of the plurality of first spatial locations in the template of the current block, one or more second spatial locations are selected in each reference template according to a respective split-shape of the multi-tap filter. Described another way, from each reference template of the plurality of reference templates in accordance with a respective portion of the plurality of portions, one or more spatial locations are selected for the plurality of second spatial locations. The one or more second spatial locations selected in each reference template includes a spatial location that is co-located with the corresponding spatial location in the current template. In some embodiments, at least one of the split-shapes of the multi-tap filter comprises a plurality of spatial locations. That is, in some embodiments, in this step, template samples at the same relative positions within templates of a first reference block, a second reference block, and a current block are fetched, and further, reference template samples that are located at neighboring position of the already fetched reference template samples are fetched only for reference blocks according to selected shapes of filters applied to reference templates. For example, if cross shapes are applied to reference templates, the central samples are fetched and then, samples located at the top, down, left, and right positions relative to the central sample in one or more of the reference templates (note that neighboring samples just from reference templates are needed because split-shape filters are applied to reference blocks to get a predictor of a current block) are fetched.

In some embodiments, at least one of the split-shapes of the multi-tap filter comprises a plurality of samples and a center sample, and the center sample is adjacent to each sample of the plurality of samples. FIG. 19 shows a selection of example non-limiting multi-tap filters. As illustrated, in respective embodiments, the multi-tap filter comprises a plurality of split-shapes of which at least one split-shape has 2 or more template samples arranged in a plurality of ways. In some embodiments, a split-shape comprises 5 samples, 9 samples, 17 samples, or another number of samples. In respective embodiments, the multi-tap filter comprises a plurality of samples arranged in a cross shape, in a x-cross shape, in a rectangular shape, or another shape. For example, in FIG. 19, multi-tap filter 0 is an 18-tap filter that consists of split-shapes (each a 9-tap square) 1924 and 1926 from the reference templates 1905 and 1907. Multi-tap filter 1 is a 10-tap filter that consists of split-shapes (each having 5 taps) 1918, which is plus-shaped, and 1920, which is x-shaped.

The split-shapes of any given multi-tap filter can all be of the same shape and size, or may have one or more split-shapes that have a shape and/or size that is different from one or more others of the split-shapes of that multi-tap filter.

The length of the multi-tap filter is a sum of lengths of each of the split-shapes of the multi-tap filter.

In some embodiments, the plurality of reference templates comprise at least a template of a first reference block and a template of a second reference block, a first reference frame comprising the first reference block temporally precedes the current frame that temporally precedes a second reference frame comprising the second reference block. In some other embodiments, such as in the low-delay configuration, the first reference frame comprising the first reference block temporally precedes the second reference frame comprising the second reference block that temporally precedes the current frame.

The current template is adjacent to a current block in the current picture and each reference template is adjacent to a reference block in a respective reference picture. The current template comprises a plurality of columns of samples nearest a left edge of the current block and a plurality of rows of samples nearest a top edge of the current block, and the reference template comprises a plurality of columns of samples nearest a left edge of the reference block and a plurality of rows of samples nearest a top edge of the reference block. The reference templates and the current template have identical size, shape and relative placement relative to its block.

In some embodiments, the first plurality of template samples comprises some samples adjacent to the current template and the second plurality of template samples comprises some samples adjacent to the reference template. In some embodiments, the samples adjacent to the current template and the samples adjacent to the reference template comprises padded samples obtained by copying the corresponding template sample values. In some embodiments, the outer samples include real sample (e.g., neighbor block sample) values. Padded samples may provide some savings in memory bandwidth. FIG. 19 shows example reference templates 1905 and 1907, and an example current template 1903. The figure also shows outer samples adjacent to each of the reference templates and to the current template. Due to the size and shape of the multi-tap filters such as, for example, filters 0 and 1 (see split-shapes 1926 and 1914 in FIG. 19) the template samples obtained by applying the multi-tap filter may include samples that are immediately adjacent to the template.

At 2204, calculating of coefficients of a multi-tap filter corresponding to the plurality of reference blocks is performed using a system of linear equations specified for (e.g., representing samples at) the plurality of second spatial locations and the plurality of first spatial locations.

This operation may include forming a first matrix comprising the samples (more particularly, values of samples) from the plurality of second spatial locations and a second matrix comprising the samples (more particular, values of samples) from the plurality of first spatial locations; and calculating the coefficients of the multi-tap filter using the first matrix and the second matrix. It should be noted, as mentioned above, that the first spatial locations are from the current template and the second spatial locations are from at least two respective reference templates. An example first matrix and an example second matrix are shown in equations (24) and (25) above, respectively.

In some embodiments, calculating the coefficients of the multi-tap filter using the first matrix and the second matrix may additionally include calculating at least one coefficient for a bias parameter using the first matrix and the second matrix. In some embodiments, a respectively different bias parameter can be obtained for each different shape in the plurality of split-shapes associated with the multi-tap filter. For example, in some embodiments, a first bias parameter and second bias parameter can be determined such that the first bias parameter is for use in association with portions of the multi-tap filter having a first shape and the second bias parameter is for use in association with portions of the multi-tap filter having a second shape that is different from the first shape. The bias parameter(s), at least in some embodiments, may represent a compensation for illumination variation between a reference block and the current block. According to some embodiments, the bias parameter(s) controls a DC level/constant offset. Additionally, some additional coefficients that apply to non-linear terms can be derived and applied to values that are obtained as a function of one of the fetched reference samples or a composition of several reference samples.

The first matrix and the second matrix may have dimensions n×m and n×1 respectively, where n is the number of first spatial locations in said plurality of first spatial locations and m is a length of the multi-tap filter. In example embodiments, the length of the multi-tap filter is the sum of lengths of each respective split-shape of the multi-tap filter.

It should be noted that a single system of linear equations is used to determine the coefficients for all the split-shapes of the multi-tap filter. Thus, in bi-predictive inter prediction of a current block, coefficients for the two split-shapes of the multi-tap filter that is used on two temporally distinct reference frames are determined using a single linear system of equations. The system of linear equation can be solved using any technique such as, for example, the Gaussian method. Alternatively, another method such as the Determinant (Cramer's) method, matrix method, etc. may be used to solve the linear system.

At 2206, predicting of the current block based on the plurality of reference blocks is performed. The predicting includes processing the plurality of reference blocks with the multi-tap filter in accordance with the calculated coefficients (e.g., from 2204) to obtain the predicted current block (i.e., prediction of the current block).

In some embodiments, the processing of the plurality of reference blocks with the multi-tap filter in accordance with the calculated coefficients to obtain the predicted current block may include calculating a plurality of adjusted reference blocks from the plurality of reference blocks, and combining the plurality of adjusted reference blocks to obtain the predicted current block. For example, a respective split-shape of the multi-tap filter, using the calculated coefficients, is applied to each reference blocks to derive the predictor of the current block. The number of reference blocks may be 2 or more. In some embodiments, one or more bias coefficients (also calculated using the linear system, as described above) may be used in deriving the prediction of the current block.

In some embodiments, the processing the plurality of reference blocks with the multi-tap filter in accordance with the calculated coefficients to obtain the predicted current block includes calculating a plurality of adjusted reference blocks from the plurality of reference blocks using the calculated coefficients, and calculating a weighted sum of the plurality of adjusted reference blocks to obtain the predicted current block.

A set of weights for calculating the weighted sum may be determined according to a configuration. For example, the weights may be determined according to BCW and a relevant image type. The encoder may transmit, in the bit stream, an indication (e.g., a flag) indicating whether or not BCW is being used for predicting a current block.

In some embodiments, such as when merge mode is being used for the current block, the set of weights is determined according to a neighboring block of the current block. As described above, in the merge mode, the set of weights can be further determined based on template matching costs of the respective candidate neighbor blocks. When the current block is predicted using BCW weights copied from a neighboring block, the encoder may transmit an indication on the bitstream to the decoder indicating the selected merge candidate.

At 2208, determining a residual to be transmitted in a bitstream is performed based on a difference between the predicted current block and the current block. The encoder encodes, in the bitstream, the residual (prediction error) based on the predicted block (from 2206) and the current block. The encoded prediction error values, when illumination compensation has been applied to the reference block, may be smaller compared to when such illumination compensation is not applied, and thus may be more efficiently encoded.

The flowchart 2200 may further include transmitting, in the bitstream, an indication to perform said predicting the current block in accordance with BCW. The encoder may transmit an indication on the bitstream that the current block is predicted using BCW. In some embodiments, flowchart 2200 may further comprise transmitting, in the bitstream, a second indication indicating a submode from a plurality of submodes of BCW. The plurality of submodes may include a first mode in which the multi-tap filter is a two-tap filter (e.g., as shown in FIG. 21) and a second mode in which the multi-tap filter comprises three or more taps (shown in FIG. 19-20). Another submode may be conventional BCW.

In some embodiments, when inter prediction merge mode is used for the current block, the encoder may not include the first indication and/or the second indication in the bitstream, and the decoder may infer the first indication and the second indication from the selected merge candidate.

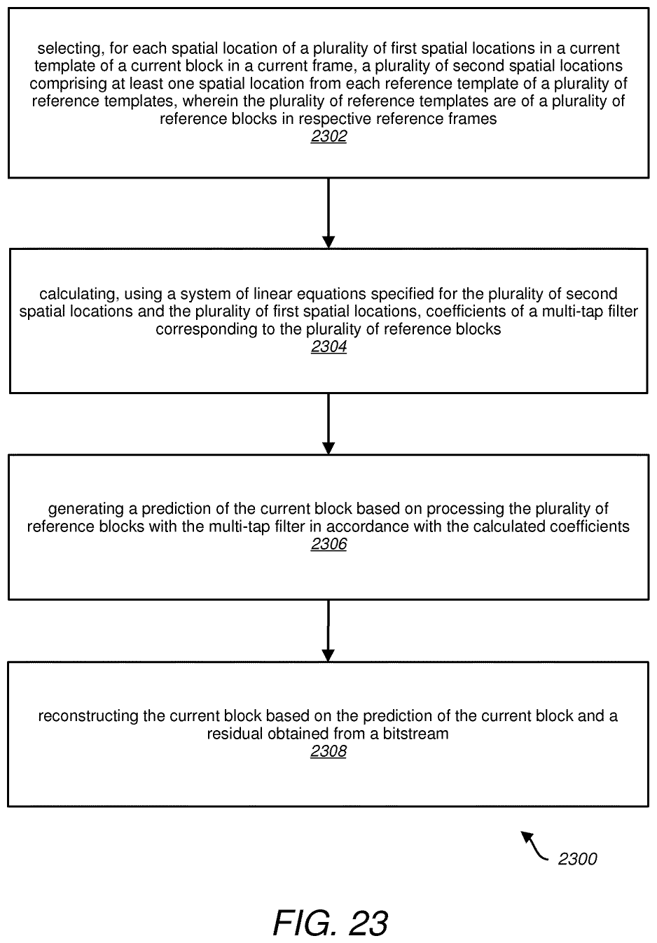

FIG. 23 illustrates a flowchart 2300 of an example method for applying split-shape multi-tap filtering to inter prediction in accordance with embodiments of the present disclosure. The method of flowchart 2300 may be implemented by a decoder, such as decoder 300 in FIG. 3.

The method of flowchart 2300 begins at 2302. At 2302, the decoder obtains a first plurality of template samples of a current block in a current picture and a second plurality of template samples of reference blocks in two or more reference pictures. For example, for each spatial location of a plurality of first spatial locations in the template of the current block in the current frame, a plurality of second spatial locations are selected from the reference templates. The plurality of second spatial locations comprise at least one spatial location from each reference template of a plurality of reference templates. The plurality of reference templates are of a plurality of reference blocks in respective reference frames.

In example embodiments, the second plurality of template samples of the reference blocks are obtained using respective portions of the split-shape multi-tap filter. The multi-tap filter is a linear filter, and in some embodiments, is a finite impulse response (FIR) filter.

For each spatial location of the plurality of first spatial locations in the template of the current block, one or more second spatial locations are selected in each reference template according to a respective split-shape of the multi-tap filter. Described another way, from each reference template of the plurality of reference templates in accordance with a respective portion of the plurality of portions, one or more spatial locations are selected for the plurality of second spatial locations. The one or more second spatial locations selected in each reference template includes a spatial location that is co-located with the corresponding spatial location in the current template. In some embodiments, at least one of the split-shapes of the multi-tap filter comprises a plurality of spatial locations.

In some embodiments, at least one of the split-shapes of the multi-tap filter comprises a plurality of samples and a center sample, and the center sample is adjacent to each sample of the plurality of samples. FIG. 19 shows a selection of example non-limiting multi-tap filters. As illustrated, in respective embodiments, the multi-tap filter comprises a plurality of split-shapes of which at least one split-shape has 2 or more template samples arranged in a plurality of ways. In some embodiments, a split-shape comprises 5 samples, 9 samples, 17 samples, or another number of samples. In respective embodiments, the multi-tap filter comprises a plurality of samples arranged in a cross shape, in a x-cross shape, in a rectangular shape, or another shape. For example, in FIG. 19, multi-tap filter 0 is an 18-tap filter that consists of split-shapes (each a 9-tap square) 1924 and 1926 from the reference templates 1905 and 1907. Multi-tap filter 1 is a 10-tap filter that consists of split-shapes (each having 5 taps) 1918, which is plus-shaped, and 1920, which is x-shaped.

The split-shapes of any given multi-tap filter can all be of the same shape and size, or may have one or more split-shapes that have a shape and/or size that is different from one or more others of the split-shapes of that multi-tap filter.

The length of the multi-tap filter is a sum of lengths of each of the split-shapes of the multi-tap filter.

At 2304, calculating of coefficients of a multi-tap filter corresponding to the plurality of reference blocks is performed using a system of linear equations specified for (e.g., representing samples at) the plurality of second spatial locations and the plurality of first spatial locations.

This operation may include forming a first matrix comprising the samples (more particularly, values of samples) from the plurality of second spatial locations and a second matrix comprising the samples (more particular, values of samples) from the plurality of first spatial locations; and calculating the coefficients of the multi-tap filter using the first matrix and the second matrix. It should be noted, as mentioned above, that the first spatial locations are from the current template and the second spatial locations are from at least two respective reference templates. An example first matrix and an example second matrix are shown in equations (24) and (25) above, respectively.

In some embodiments, calculating the coefficients of the multi-tap filter using the first matrix and the second matrix may additionally include calculating at least one bias parameter using the first matrix and the second matrix. In some embodiments, a respectively different bias parameter can be obtained for each different shape in the plurality of split-shapes associated with the multi-tap filter. For example, in some embodiments, a first bias parameter and second bias parameter can be determined such that the first bias parameter is for use in association with portions of the multi-tap filter having a first shape and the second bias parameter is for use in association with portions of the multi-tap filter having a second shape that is different from the first shape. The bias parameter(s), at least in some embodiments, may represent a compensation for illumination variation between a reference block and the current block.

The first matrix and the second matrix may have dimensions n×m and n×1 respectively, where n is the number of first spatial locations in said plurality of first spatial locations and m is a length of the multi-tap filter. In example embodiments, the length of the multi-tap filter is the sum of lengths of each respective split-shape of the multi-tap filter.

It should be noted that a single system of linear equations is used to determine the coefficients for all the split-shapes of the multi-tap filter. Thus, in bi-predictive inter prediction of a current block, coefficients for the two split-shapes of the multi-tap filter that is used on two temporally distinct reference frames are determined using a single linear system of equations. The system of linear equation can be solved using any technique such as, for example, the Gaussian method.

At 2306, predicting of the current block based on the plurality of reference blocks is performed. The predicting includes processing the plurality of reference blocks with the multi-tap filter in accordance with the calculated coefficients (e.g., from 2304) to obtain the predicted current block (i.e., prediction of the current block).

In some embodiments, the processing of the plurality of reference blocks with the multi-tap filter in accordance with the calculated coefficients to obtain the predicted current block may include calculating a plurality of adjusted reference blocks from the plurality of reference blocks, and combining the plurality of adjusted reference blocks to obtain the predicted current block. More particularly, in some embodiments, the processing the plurality of reference blocks with the multi-tap filter in accordance with the calculated coefficients to obtain the predicted current block includes calculating a plurality of adjusted reference blocks from the plurality of reference blocks using the calculated coefficients and at least one bias parameter, and calculating a weighted sum of the plurality of adjusted reference blocks to obtain the predicted current block.

In some embodiments, a set of weights for calculating the weighted sum may be determined according to a configuration. For example, the weights may be determined according to BCW and a relevant image type. The encoder may transmit, in the bit stream, an indication (e.g., a flag) indicating whether or not BCW is being used for predicting a current block.

In some embodiments, such as when merge mode is being used for the current block, the set of weights is determined according to a neighboring block of the current block. As described above, in the merge mode, the set of weights can be further determined based on template matching costs of the respective candidate neighbor blocks. When the current block is predicted using BCW weights copied from a neighboring block, the encoder may transmit an indication on the bitstream to the decoder indicating the selected merge candidate.

An illumination compensation function may be applied to the reference block to generate the predicted block, using the determined plurality of coefficients and a bias term. Equation (22) may be used in calculating the predicted samples. In some embodiments, the applying includes calculating each predicted sample of the predicted block based at least on the determined plurality of coefficients, a reference sample, and the bias term, wherein the reference sample is from the reference block.

At 2308, reconstructing of the current block is performed based on the predicted current block and a residual obtained from the bitstream.

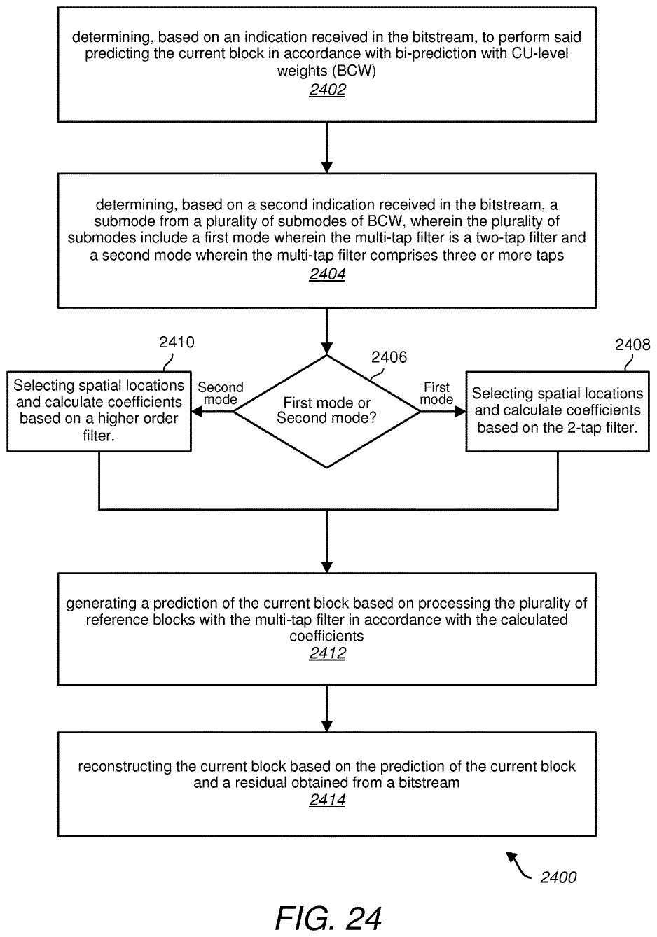

FIG. 24 illustrates a flowchart 2400 of an example method that adaptively uses one of a plurality of submodes for BCW inter prediction of a current block. The process of flowchart 2400 may be performed by a decoder such as decoder 300 in FIG. 3.

The process begins at 2402. At 2402, based on an indication (e.g., flag) received in the bitstream, the decoder determines to perform the predicting of the current block in accordance with BCW.

At 2404, based on a second indication received in the bitstream, the decoder determines a submode from a plurality of submodes of BCW. The plurality of submodes include a first mode where the multi-tap filter is a two-tap filter and a second mode where the multi-tap filter comprises three or more taps.

At 2406 it is determined which submode of BCW is to be used in predicting the current block.

If the selected submode is the first mode, then at 2408 the decoder selects spatial locations and calculates coefficients based on the 2-tap filter. As example 2-tap filter was shown in FIG. 21. The calculation of coefficients in first mode may be performed by a technique such as the Gram-Schmidt technique described above.

If the selected submode is the second mode, then at 2410, the decoder selects spatial locations and calculates coefficients based on a multi-tap filter. A process such as operations 2302 and 2304 can be performed in order to select template samples and calculate coefficients of the multi-tap filter.

At 2412, the current block is predicted based on the plurality of reference blocks. The predicting includes processing the plurality of reference blocks with the multi-tap filter in accordance with the calculated coefficients to obtain the predicted current block.

At 2414, reconstructing the current block based on the predicted current block and a residual obtained from the bitstream.

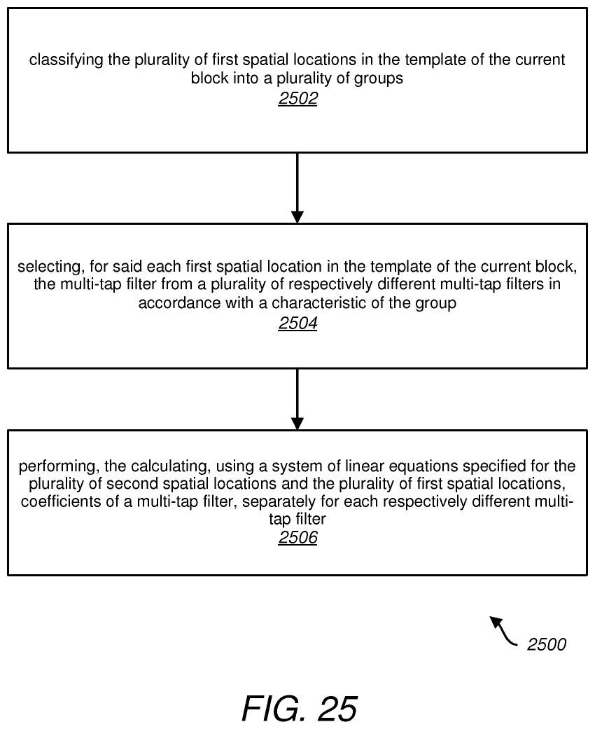

FIG. 25 illustrates a flowchart 2500 for an example method in which template samples are classified into different groups according to their properties and different types of split-shapes of the multi-tap filter are applied to the different groups. For example, template samples may belong to edges, smooth regions, or transition areas between samples of edges and smooth regions, and with this process, different types of split-shape filters are applied to different groups to derive filter coefficients that are more optimal for each group of samples. In some examples, flowchart 2500 may be performed by an encoder (e.g., encoder 200 of FIG. 2) or a decoder (e.g., decoder 300 of FIG. 3).

Flowchart 2500 begins at 2502. At 2502, the plurality of first spatial locations in the template of the current block is classified into a plurality of groups. For example, in some embodiments, template samples may be grouped into three groups: as belonging to edges, smooth regions, or transition areas between samples of edges and smooth regions. The classification can be performed using any classifier, for example, a Laplace classifier.

At 2504, for each first spatial location in the current template, the multi-tap filter is selected from a plurality of respectively different multi-tap filters in accordance with a characteristic of the group. For example, the plurality of multi-tap filters may include filters with different sizes and/or shapes that are identified as being suitable for each of the respective groups of template samples. Then samples of each group are selected using the corresponding selected multi-tap filter. The selection of samples may be performed in a similar manner as described in relation to 2202 and 2302 above.

At 2506, the calculating, using a system of linear equations specified for the plurality of second spatial locations (e.g., for second samples at the plurality of second spatial locations) from the reference templates and the plurality of first spatial locations from the current template (e.g., for first samples at the plurality of first spatial locations), coefficients of a multi-tap filter is performed separately for each respectively different multi-tap filter. That is, for each group of samples a respectively different system of linear equations (e.g., in accordance with equations (24) and (25)) is constructed and solved to determine multi-tap filter coefficients. The calculation may be performed in a manner similar to that described in relation to 2204 or 2304 above.

After 2502-2506 are performed to obtain the coefficients for each of the split-shape multi-tap filters corresponding to the respective groups of template samples, the samples of the current block can be classified into different groups in a similar manner to the current template, and the selected split-shape multi-tap filter may be applied to the corresponding samples in the reference blocks to determine the predicted block. Further description of the prediction of the current block is available in relation to 2206 and 2306 above.

After the predicted current block is determined, then depending on whether the method of flowchart 2500 is being performed by the encoder or the decoder, either the residual is determined or the current block is reconstructed.

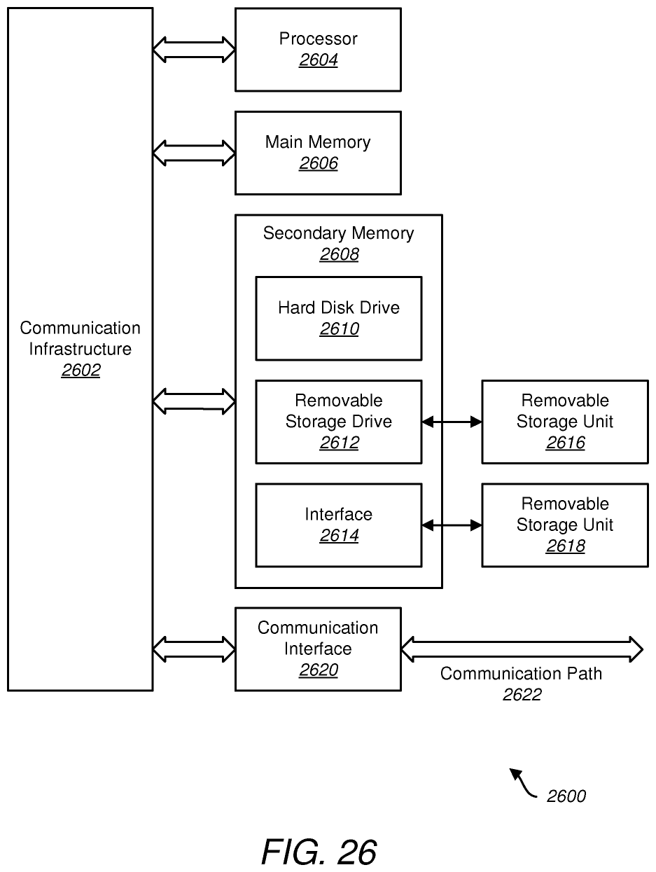

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 2600 is shown in FIG. 26. Blocks depicted in the figures above, such as the blocks in FIGS. 1, 2, and 3, may execute on one or more computer systems 2600. Furthermore, each of the steps of the flowcharts depicted in this disclosure may be implemented on one or more computer systems 2600.

Computer system 2600 includes one or more processors, such as processor 2604. Processor 2604 may be, for example, a special purpose processor, general purpose processor, microprocessor, or digital signal processor. Processor 2604 may be connected to a communication infrastructure 2602 (for example, a bus or network). Computer system 2600 may also include a main memory 2606, such as random access memory (RAM), and may also include a secondary memory 2608.

Secondary memory 2608 may include, for example, a hard disk drive 2610 and/or a removable storage drive 2612, representing a magnetic tape drive, an optical disk drive, or the like. Removable storage drive 2612 may read from and/or write to a removable storage unit 2616 in a well-known manner. Removable storage unit 2616 represents a magnetic tape, optical disk, or the like, which is read by and written to by removable storage drive 2612. As will be appreciated by persons skilled in the relevant art(s), removable storage unit 2616 includes a computer usable storage medium having stored therein computer software and/or data.

In alternative implementations, secondary memory 2608 may include other similar means for allowing computer programs or other instructions to be loaded into computer system 2600. Such means may include, for example, a removable storage unit 2618 and an interface 2614. Examples of such means may include a program cartridge and cartridge interface (such as that found in video game devices), a removable memory chip (such as an EPROM or PROM) and associated socket, a thumb drive and USB port, and other removable storage units 2618 and interfaces 2614 which allow software and data to be transferred from removable storage unit 2618 to computer system 2600.

Computer system 2600 may also include a communications interface 2620. Communications interface 2620 allows software and data to be transferred between computer system 2600 and external devices. Examples of communications interface 2620 may include a modem, a network interface (such as an Ethernet card), a communications port, etc. Software and data transferred via communications interface 2620 are in the form of signals which may be electronic, electromagnetic, optical, or other signals capable of being received by communications interface 2620. These signals are provided to communications interface 2620 via a communications path 2622. Communications path 2622 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 2616 and 2618 or a hard disk installed in hard disk drive 2610. These computer program products are means for providing software to computer system 2600. Computer programs (also called computer control logic) may be stored in main memory 2606 and/or secondary memory 2608. Computer programs may also be received via communications interface 2620. Such computer programs, when executed, enable the computer system 2600 to implement the present disclosure as discussed herein. In particular, the computer programs, when executed, enable processor 2604 to implement the processes of the present disclosure, such as any of the methods described herein. Accordingly, such computer programs represent controllers of the computer system 2600.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
selecting, for each spatial location of a plurality of first spatial locations in a current template of a current block in a current frame, a plurality of second spatial locations comprising at least one spatial location from each reference template of a plurality of reference templates, wherein the plurality of reference templates are associated with a plurality of reference blocks in respective reference frames;
calculating, using a system of equations specified for the plurality of second spatial locations and the plurality of first spatial locations, coefficients of a multi-tap filter corresponding to the plurality of reference blocks;
generating a prediction of the current block based on applying, to the plurality of reference blocks, the multi-tap filter in accordance with the calculated coefficients; and
coding the current block based on the prediction of the current block.

2. The method according to claim 1, wherein the multi-tap filter comprises a plurality of portions, and wherein the selecting a plurality of second spatial locations comprises:
selecting, from each reference template of the plurality of reference templates in accordance with a respective portion of the plurality of portions, one or more spatial locations for the plurality of second spatial locations.

3. The method according to claim 2, wherein a length of the multi-tap filter is a sum of lengths of each of the plurality of portions.

4. The method according to claim 1, wherein the plurality of reference templates of the plurality of reference blocks comprise a template of a first reference block and a template of a second reference block, and wherein a first reference frame comprising the first reference block temporally precedes the current frame that temporally precedes a second reference frame comprising the second reference block.

5. The method according to claim 1, wherein the plurality of reference templates of the plurality of reference blocks comprise a template of a first reference block and a template of a second reference block, and wherein a first reference frame comprising the first reference block temporally precedes a second reference frame comprising the second reference block that temporally precedes the current frame.

6. The method according to claim 1, wherein the calculating coefficients of a multi-tap filter, comprises:
generating a first matrix comprising samples from the plurality of second spatial locations and a second matrix comprising samples from the plurality of first spatial locations; and
calculating the coefficients of the multi-tap filter using the first matrix and the second matrix.

7. The method according to claim 1, wherein the applying, to the plurality of reference blocks, the multi-tap filter in accordance with the calculated coefficients comprises:
calculating a plurality of adjusted reference blocks from the plurality of reference blocks; and
combining the plurality of adjusted reference blocks to obtain the prediction of the current block.

8. The method according to claim 1, wherein the applying, to the plurality of reference blocks, the multi-tap filter in accordance with the calculated coefficients comprises:
calculating a plurality of adjusted reference blocks from the plurality of reference blocks using the calculated coefficients; and
calculating a weighted sum of the plurality of adjusted reference blocks to obtain the prediction of the current block.

9. An apparatus, comprising:
one or more processors; and
memory storing instructions that, when executed by the one or more processors, cause the apparatus to:
select, for each spatial location of a plurality of first spatial locations in a current template of a current block in a current frame, a plurality of second spatial locations comprising at least one spatial location from each reference template of a plurality of reference templates, wherein the plurality of reference templates are associated with a plurality of reference blocks in respective reference frames;
calculate, using a system of equations specified for the plurality of second spatial locations and the plurality of first spatial locations, coefficients of a multi-tap filter corresponding to the plurality of reference blocks;
generate a prediction of the current block based on applying, to the plurality of reference blocks, the multi-tap filter in accordance with the calculated coefficients; and
code the current block based on the prediction of the current block.

10. The apparatus according to claim 9, wherein the multi-tap filter comprises a plurality of portions, and wherein to select the plurality of second spatial locations, the apparatus is further caused to:
select, from each reference template of the plurality of reference templates in accordance with a respective portion of the plurality of portions, one or more spatial locations for the plurality of second spatial locations.

11. The apparatus according to claim 10, wherein a length of the multi-tap filter is a sum of lengths of each of the plurality of portions.

12. The apparatus according to claim 9, wherein the plurality of reference templates of the plurality of reference blocks comprise a template of a first reference block and a template of a second reference block, and wherein a first reference frame comprising the first reference block temporally precedes the current frame that temporally precedes a second reference frame comprising the second reference block.

13. The apparatus according to claim 9, wherein the plurality of reference templates of the plurality of reference blocks comprise a template of a first reference block and a template of a second reference block, and wherein a first reference frame comprising the first reference block temporally precedes a second reference frame comprising the second reference block that temporally precedes the current frame.

14. The apparatus according to claim 9, wherein the calculating coefficients of a multi-tap filter, comprises:
generating a first matrix comprising samples from the plurality of second spatial locations and a second matrix comprising samples from the plurality of first spatial locations; and
calculating the coefficients of the multi-tap filter using the first matrix and the second matrix.

15. The apparatus according to claim 9, wherein the applying, to the plurality of reference blocks, the multi-tap filter in accordance with the calculated coefficients comprises:
calculating a plurality of adjusted reference blocks from the plurality of reference blocks; and
combining the plurality of adjusted reference blocks to obtain the prediction of the current block.

16. The apparatus according to claim 9, wherein the applying, to the plurality of reference blocks, the multi-tap filter in accordance with the calculated coefficients comprises:
calculating a plurality of adjusted reference blocks from the plurality of reference blocks using the calculated coefficients; and
calculating a weighted sum of the plurality of adjusted reference blocks to obtain the prediction of the current block.

17. A non-transitory computer-readable medium comprising instructions that, when executed by one or more processors of an apparatus, cause the apparatus to:
select, for each spatial location of a plurality of first spatial locations in a current template of a current block in a current frame, a plurality of second spatial locations comprising at least one spatial location from each reference template of a plurality of reference templates, wherein the plurality of reference templates are associated with a plurality of reference blocks in respective reference frames;
calculate, using a system of equations specified for the plurality of second spatial locations and the plurality of first spatial locations, coefficients of a multi-tap filter corresponding to the plurality of reference blocks;
generate a prediction of the current block based on applying, to the plurality of reference blocks, the multi-tap filter in accordance with the calculated coefficients; and
code the current block based on the prediction of the current block.

18. The non-transitory computer-readable medium according to claim 17, wherein the multi-tap filter comprises a plurality of portions, and wherein to select the plurality of second spatial locations, the apparatus is further caused to:
selecting, from each reference template of the plurality of reference templates in accordance with a respective portion of the plurality of portions, one or more spatial locations for the plurality of second spatial locations.

19. The non-transitory computer-readable medium according to claim 18, wherein a length of the multi-tap filter is a sum of lengths of each of the plurality of portions.

20. The non-transitory computer-readable medium according to claim 17, wherein the multi-tap filter is a linear filter.
